(19) United States
(12) Patent Application Publication
(10) Pub. No.: US 2026/0291682 A1
(43) Pub. Date: Sep. 24, 2026

(54) SRS DETECTION FOR CLI IDENTIFICATION ASSOCIATED WITH SCHEDULED UL TRANSMISSION

(71) Applicant: InterDigital Patent Holdings, Inc., Wilmington, DE (US)

(72) Inventors: Jonghyun Park, Syosset, NY (US); Moon IL Lee, Melville, NY (US); Tao Deng, New York, NY (US); Aata El Hamss, Laval, CA (US); Nazli Khan Beigi, Longueuil, CA (US); Virgile Garcia, Antibes (FR)

(73) Assignee: InterDigital Patent Holdings, Inc., Wilmington, DE (US)

(21) Appl. No.: 19/088,327

(22) Filed: Mar. 24, 2025

(51) Int. Cl. H04L 5/00; H04B 17/318; H04W 24/10

(52) U.S. Cl. CPC H04L 5/0051; H04B 17/328; H04L 5/0044; H04W 24/10

(57) ABSTRACT

A method comprises receiving reference signal (RS) configuration information that comprises information indicating a plurality of sounding reference signal (SRS) resources. The method comprises receiving uplink transmission configuration information, that comprises information for an uplink transmission, an indication to perform an SRS measurement associated with the uplink transmission, and an association between the uplink transmission and a set of SRS resources to perform the SRS measurements. The method comprises transmitting the uplink transmission; determining time resources of the set of SRS resources associated with the uplink transmission, based on the association between the uplink transmission and a set of SRS resources to perform the SRS measurements; performing measurements on the set of SRS resources associated with the uplink transmission; determining a subset of SRS resources based on the performed measurement; and sending a report to a network node comprising the determined subset of SRS resources.

### BACKGROUND

A work item on New Radio (NR) duplex operation has been agreed. This technology may be a great foundation in improving conventional time division duplexing (TDD) operation by enhancing uplink (UL) coverage, improving capacity, reducing latency, and others. The conventional TDD is based on splitting the time domain between the uplink and downlink (DL). In NR release 19, the feasibility of allowing full duplex, or more specifically, sub-band non-overlapping full duplex (SBFD) at a gNB within a conventional TDD band is investigated, where an UL sub-band may be configured within a DL slot/symbol.

In future 5G releases and/or in 6G, the technology may evolve to include more flexible, dynamic duplexing, for example, dynamic SBFD, in-band/overlapping full duplex, where cross-link interference (CLI) may become a more common interference issue

### SUMMARY

A method may be used by a first wireless transmit/receive unit (WTRU). The method may comprise receiving reference signal (RS) configuration information, from a network node. The RS configuration information may comprise information indicating a plurality of sounding reference signal (SRS) resources. The method may comprise receiving uplink transmission configuration information. The uplink transmission configuration information may comprise information for an uplink transmission, an indication to perform an SRS measurement associated with the uplink transmission, and an association between the uplink transmission and a set of SRS resources to perform the SRS measurements. The method may comprise transmitting the uplink transmission. The method may comprise determining time resources of the set of SRS resources associated with the uplink transmission, based on the association between the uplink transmission and a set of SRS resources to perform the SRS measurements. The method may comprise performing measurements on the set of SRS resources associated with the uplink transmission based on the indication to perform an SRS measurement associated with the uplink transmission and based on the determined time resources. The method may comprise determining a subset of SRS resources, from the set of SRS resources, to report to the network node, based on the performed measurements. The method may comprise sending a report to the network node comprising the determined subset of SRS resources. Each SRS resource of the plurality of SRS resources may correspond to one or more second WTRUs. The RS configuration information may comprise SRS resource information including, for each SRS resource, an index, time resources, frequency resources, and a sequence identity, and wherein the RS configuration information comprises a SRS reference signal received power (RSRP) threshold value. The determining a subset of SRS resources may further comprise including an SRS resource in the subset of SRS resources on a condition that the measurement of the SRS resource is greater than the SRS RSRP threshold value. The uplink configuration information may further comprise information for a physical downlink shared channel (PUSCH) transmission including a transmission beam, time resources and frequency resources; and reporting configuration information. The determining the time resources of the set of SRS resources may be determining time resources for each SRS resource of the set of SRS resources. The sending the report may be based on the reporting configuration information. The report may include an index of each SRS resource of the subset of SRS resources and a measurement value of each SRS resource of the subset of SRS resources. The uplink transmission may be a physical downlink shared channel (PUSCH) transmission and the uplink transmission may be transmitted based on the uplink transmission configuration information. The method may comprise using a receiver beam for the measurements on the set of SRS resources, wherein the receiver beam is a same beam used for transmitting the uplink transmission.

A first wireless transmit/receive unit (WTRU) may comprise a receiver, a transmitter, and a processor. The receiver may be configured to receive reference signal (RS) configuration information, from a network node. The RS configuration information may comprise information indicating a plurality of sounding reference signal (SRS) resources. The receiver may be further configured to receive uplink transmission configuration information. The uplink transmission configuration information may comprise information for an uplink transmission, an indication to perform an SRS measurement associated with the uplink transmission, and an association between the uplink transmission and a set of SRS resources to perform the SRS measurements. The transmitter may be configured to transmit the uplink transmission. The processor may be configured to determine time resources of the set of SRS resources associated with the uplink transmission, based on the association between the uplink transmission and a set of SRS resources to perform the SRS measurements. The processor may be further configured to perform measurements on the set of SRS resources associated with the uplink transmission based on the indication to perform an SRS measurement associated with the uplink transmission and based on the determined time resources. The processor may be further configured to determine a subset of SRS resources, from the set of SRS resources, to report to the network node, based on the performed measurements. The transmitter may be further configured to send a report to the network node comprising the determined subset of SRS resources. Each SRS resource of the plurality of SRS resources corresponds to one or more second WTRUs. The RS configuration information may comprise SRS resource information including, for each SRS resource, an index, time resources, frequency resources, and a sequence identity. The RS configuration information may comprise a SRS reference signal received power (RSRP) threshold value. The processor may be further configured to include an SRS resource in the subset of SRS resources on a condition that the measurement of the SRS resource is greater than the SRS RSRP threshold value. The uplink configuration information may further comprise information for a physical downlink shared channel (PUSCH) transmission including a transmission beam, time resources and frequency resources; and reporting configuration information. The processor may be further configured to determine the time resources of the set of SRS resources for each SRS resource of the set of SRS resources. The transmitter may be further configured to send the report based on the reporting configuration information. The report may include an index of each SRS resource of the subset of SRS resources and a measurement value of each SRS resource of the subset of SRS resources. The uplink transmission may be a physical downlink shared channel (PUSCH) transmission and the uplink transmission may be transmitted based on the uplink transmission configuration information. The receiver and the processor may be further configured to use a receiver beam for the measurements on the set of SRS resources, wherein the receiver beam is a same beam used for transmitting the uplink transmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of Cross Link Interference (CLI), inter-gNBs and inter-WTRUs;

FIG. 3 shows an example of transmission triggered sounding reference signal (SRS) measurement;

FIG. 4 shows an example SBFD configuration;

FIG. 5 shows an example procedure for SRS detection associated with a transmission;

FIG. 6 shows an example procedure for SRS transmission triggered by a CLI event; and

FIG. 7 shows an example procedure for determination of SRS resources for SRS detection associated with an uplink (UL) transmission.

### DETAILED DESCRIPTION

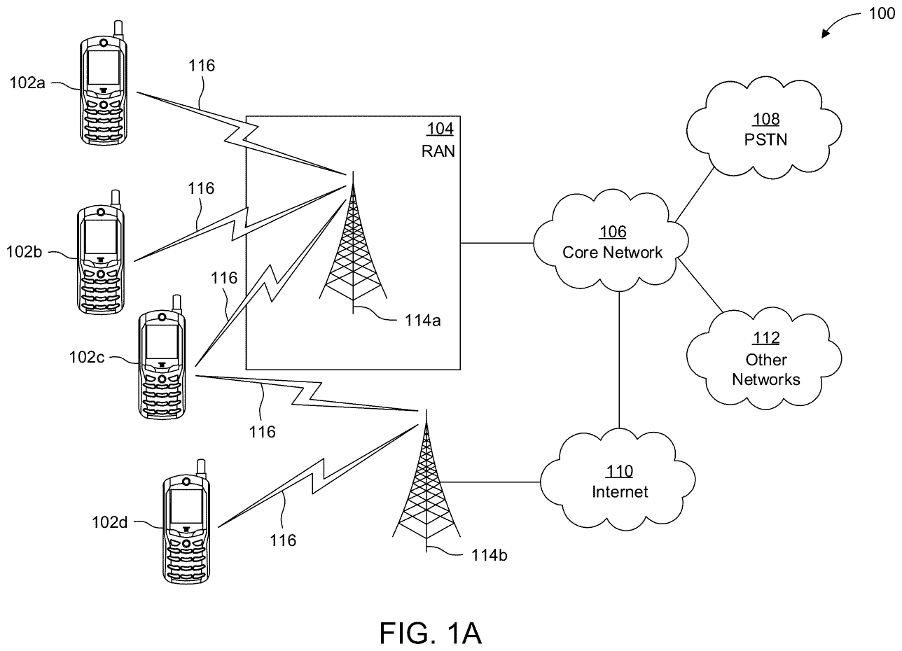

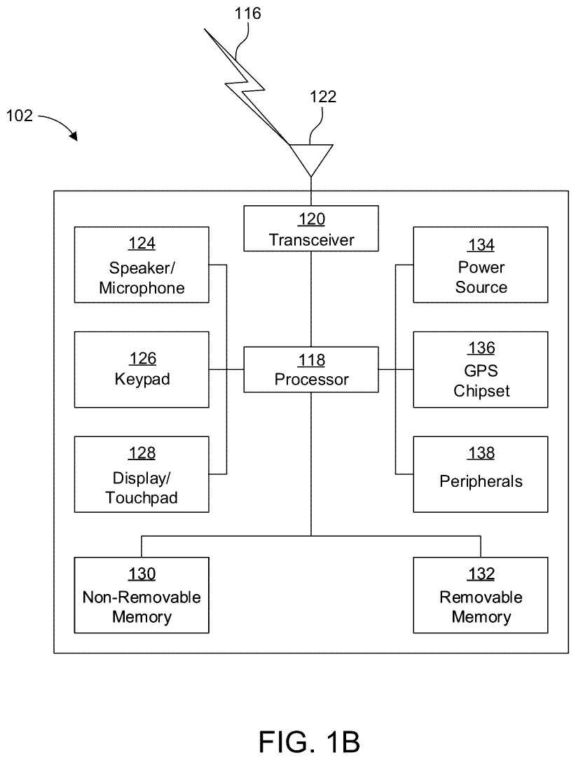

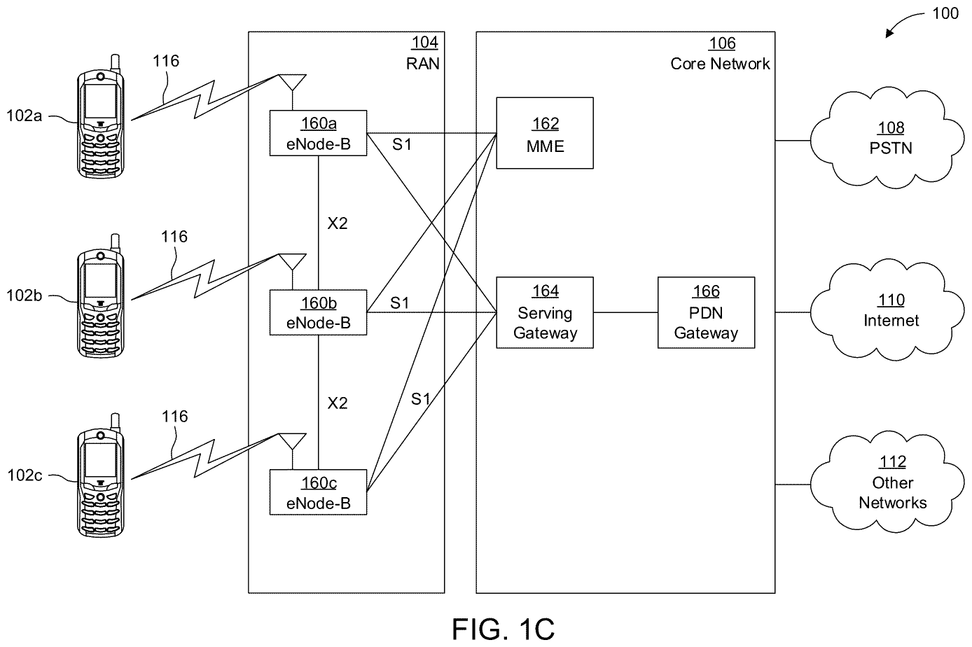

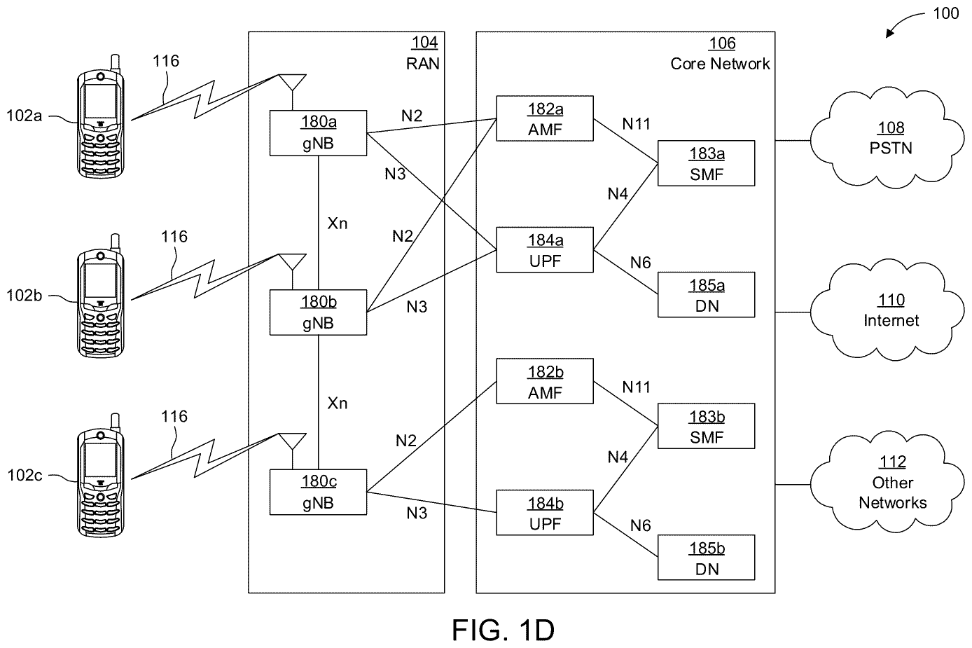

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

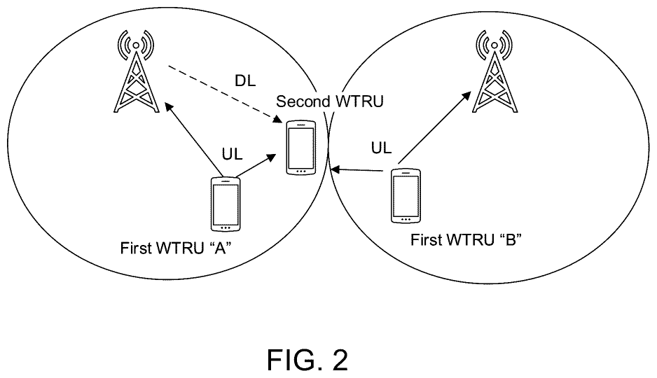

The realization of SBFD, or more advanced duplexing schemes, is subject to resolving the key challenges raised due to cross-link interferences (CLI). The CLI may be measured at both a WTRU that may be interfered with and a WTRU that may cause interference, for example, using reciprocity. For WTRUs, the UL-to-DL CLI happens, for example as shown in FIG. 2, when an UL transmission from a first WTRU (e.g., First WTRU “A”/First WTRU “B” in FIG. 2) causes interferences at a second WTRU (Second WTRU in FIG. 2) receiving DL transmissions.

WTRUs may be subject to different types of UL-to-DL CLI:

WTRUs may be subject to intra-frequency, inter-cell (co-channel) CLI, when neighboring cells are configured with different link directions in the same carrier frequency, either for SBFD, dynamic/flexible TDD cases, (overlapping/in-band) full duplex, or cross-division duplexing (XDD).

WTRUs may be subject to intra-frequency, inter-subband CLI, where an UL transmission, from the serving cell or a neighboring cell, in a SBFD sub-band creates leakage interference in an adjacent DL sub-band, for the SBFD scenario.

WTRUs may be subject to inter-frequency CLI, where the UL transmission in an adjacent frequency carrier, from the serving cell or a neighboring cell, creates leakage in the adjacent DL sub-band, for both SBFD and dynamic/flexible TDD scenarios.

In SBFD, as in release 19, and future SBFD/FD operations, CLI management and identification is network-controlled, for example, sounding reference signal (SRS) transmissions and measurements are aligned through the network (e.g., periodic, semi-persistent or aperiodic configuration possible), which is slow and require signaling overheads.

A WTRU performing a transmission may generate CLI to one or multiple WTRUs in its vicinity. Performing one-by-one configuration/command of CLI measurement through network configuration is slow and may not include the different affected WTRUs.

A problem is how to let a WTRU quickly identify one or multiple CLI interferences after a transmission.

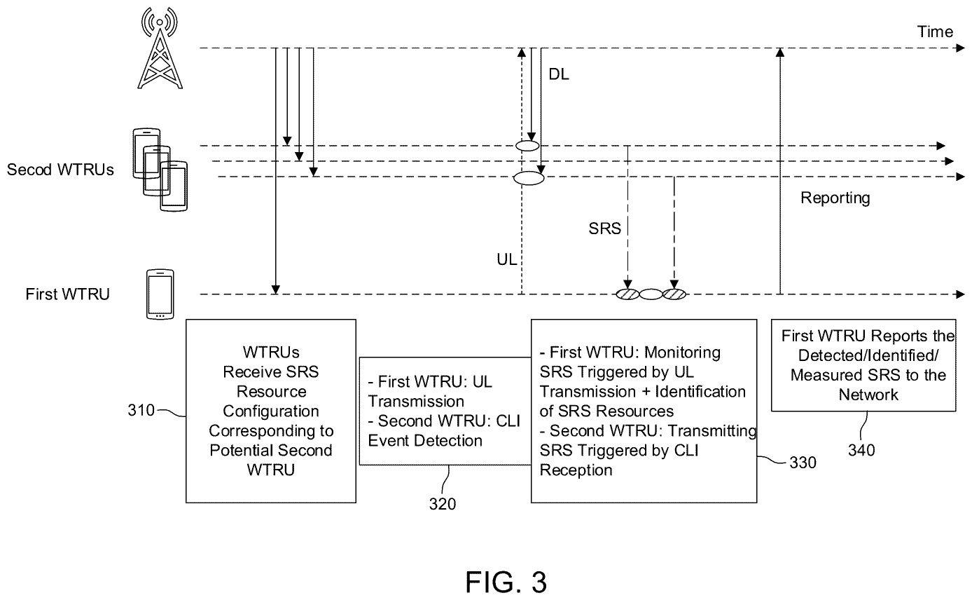

FIG. 3 shows an example of a transmission triggered SRS measurement.

In an embodiment, a first WTRU, which may be a WTRU which may cause interference, may be configured with a set of SRS monitoring resources 310, each corresponding to an SRS transmission resource of a potential second WTRU, which may be a WTRU that may be interfered with or experience interference. Both the first and second WTRUs may be configured with a same association of SRS resource to a transmission or a CLI event. The first WTRU may perform an uplink (UL) transmission 320, for example, a scheduled physical uplink shared channel (PUSCH), that may cause CLI to one or more second WTRUs. The one or more second WTRUs may determine the CLI event, for example, based on measurements (e.g. CLI-reference signal received power (RSSI) over the UL sub-band) or based on DL reception failures 320. If a second WTRU detects a CLI, it may trigger the transmission of the SRS associated with the CLI 330. The first WTRU may be configured to monitor the set of SRS resources associated with the PUSCH transmission 330. The first WTRU may detect/identify the SRS resources on which a SRS transmission was performed, if any, and may report the CLI to the network 340.

An first WTRU, which may be a WTRU which may cause interference, may be pre-configured and/or receive configuration information, for example, from the network using, for example radio resource control (RRC) signaling The pre-configuration or configuration information may comprise, for example, plurality of SRS resources and configurations, including their index, time, frequency, comb, and/or sequence parameters. Each SRS resource may correspond to a potential second WTRU, which may be a WTRU that may be interfered with or experience interference. The pre-configuration or configuration information may comprise an associated threshold value, for example, using (L1-)SRS-reference signal received power (RSRP).

The first WTRU may receive an UL transmission configuration associated with an SRS detection, for example, a PUSCH transmission configured by a downlink control information (DCI) including: an UL transmission configuration (e.g., transmission beam, time and frequency resources); an indication to perform a SRS detection associated with the transmission, where the indication may indicate a set of SRS resources from the plurality of SRS resources to perform detection on; a mapping or association between the UL transmission and the associated set of SRS resources to monitor, for example, based on a time offset starting at the UL transmission; and a reporting configuration (e.g., UCI format and resources).

The first WTRU may perform an UL transmission, for example, a PUSCH based on the received transmission configuration, using the resources and beams indicated by the network.

The first WTRU may determine the time resources (e.g. slot/symbol) of the indicated set of SRS resources associated with the UL transmission, based on the received mapping or association and the UL transmission time resource (e.g., the UL transmission time resource+the received time offset).

The first WTRU may perform measurements on the set of SRS resources associated with the performed UL transmission on the determined time resources (e.g., using as receiver beam the beam used for the performed UL transmission).

The first WTRU may determine a subset of SRS resources, among the measured set of SRS resources, that are above or greater than the corresponding configured (L1-)SRS-RSRP threshold.

The first WTRU may report to the network the determined subset of SRS resources, for example, using the corresponding received reporting configuration (e.g., including the index of the SRS resources from the determined subsets, and/or their measurement value).

A benefit of the above procedure may be quick identification of CLI WTRU pairs using individual SRS signatures that are transmitted after a CLI event and measured by the first WTRU.

Hereinafter, ‘a’ and ‘an’ and similar phrases may be interpreted as ‘one or more’ and ‘at least one’. Similarly, any term which ends with the suffix ‘(s)’ may be interpreted as ‘one or more’ and ‘at least one’. The term ‘may’ may be interpreted as ‘may, for example’.

A symbol ‘/’ (e.g., forward slash) may be used herein to represent ‘and/or’, where for example, ‘A/B’ may imply ‘A and/or B’.

Hereinafter, the term “sub-band” may be used to refer to a frequency-domain resource and may be characterized by at least one of the following: a set of resource blocks (RBs); a set of resource block sets (RB sets), for example, when a carrier has intra-cell guard bands; a set of interlaced resource blocks; a bandwidth part, or portion thereof; and/or a carrier, or portion thereof.

For example, a sub-band may be characterized by a starting resource block (RB) and number of RBs for a set of contiguous RBs within a bandwidth part. A sub-band may also be defined by the value of a frequency-domain resource allocation field and bandwidth part index.

Hereinafter, the term “XDD” may be used to refer to a sub-band-wise duplex (e.g., either UL or DL being used per sub-band) and may be characterized by at least one of the following: cross division duplex (e.g., sub-band-wise FDD within a TDD band); sub-band-based full duplex (e.g., full duplex as both UL and DL are used/mixed on a symbol/slot, but either UL or DL being used per sub-band on the symbol/slot); frequency-domain multiplexing (FDM) of DL/UL transmissions within a TDD spectrum; a sub-band non-overlapping full duplex (SBFD) (e.g., non-overlapped sub-band full-duplex); a full duplex other than a same-frequency (e.g., spectrum sharing, sub-band-wise-overlapped) full duplex; and/or an advanced duplex method, e.g., other than (pure) TDD or FDD.

Hereinafter, the term “dynamic(/flexible) TDD” may be used to refer to a TDD system/cell which may dynamically (and/or flexibly) change/adjust/switch a communication direction (e.g., a downlink, an uplink, or a sidelink) on a time instance (e.g., slot, symbol, subframe, and/or the like). In an example, in a system employing dynamic/flexible TDD, a component carrier (CC) or a bandwidth part (BWP) may have one single type among downlink ‘D’, uplink ‘U’, and flexible ‘F’ on a symbol/slot, based on an indication by, for example, a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, transmission/reception point (TRP)) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

Hereinafter, the term “SBFD” may be used to refer to a sub-band-wise duplex (e.g., either UL or DL being used per sub-band) and may be characterized by at least one of the following: cross division duplex (e.g., XDD, sub-band-wise FDD within a TDD band); sub-band-based full duplex (e.g., full duplex as both UL and DL are used/mixed on a symbol/slot, but either UL or DL being used per sub-band on the symbol/slot); frequency-domain multiplexing (FDM) of DL/UL transmissions within a TDD spectrum; a sub-band non-overlapping full duplex (SBFD) (e.g., non-overlapped sub-band full-duplex); a full duplex other than a same-frequency (e.g., spectrum sharing, sub-band-wise-overlapped) full duplex; and/or an advanced duplex method, for example, other than (pure) TDD or FDD, for example, partial in-band full duplex, sub-band overlapping full duplex, in-band full duplex (IBFD).

A property of a grant or assignment may comprise at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, by medium access control (MAC) or by RRC for the scheduling the grant or assignment.

An indication by DCI may comprise an explicit indication by a DCI field or by a radio network temporary identifier (RNTI) used to mask the cyclic redundancy check (CRC) of a physical downlink control channel (PDCCH).

An indication by DCI may comprise an implicit indication by a property such as DCI format, DCI size, control resource set (Coreset) or search space, aggregation level, first resource element of the received DCI (e.g., index of first control channel element (CCI)), where the mapping between the property and the value may be signaled by RRC or MAC.

Hereafter, a signal may be interchangeably used with one or more of following: sounding reference signal (SRS); channel state information-reference signal (CSI-RS); demodulation reference signal (DM-RS); phase tracking reference signal (PT-RS); synchronization signal block (SSB), and still consistent with this disclosure.

Hereafter, a channel may be interchangeably used with one or more of following: physical downlink control channel (PDCCH); physical downlink shared channel (PDSCH); physical uplink control channel (PUCCH); physical uplink shared channel (PUSCH); physical random access channel (PRACH) and still consistent with this disclosure.

Hereafter, downlink reception may be used interchangeably with receive (Rx) occasion, PDCCH, PDSCH, SSB reception, and still consistent with this disclosure.

Hereafter, uplink transmission may be used interchangeably with transmission (Tx) occasion, PUCCH, PUSCH, PRACH, SRS transmission, and still consistent with this disclosure.

Hereafter, reference signal (RS) may be interchangeably used with one or more of RS resource, RS resource set, RS port and RS port group, and still consistent with this disclosure.

Hereafter, RS may be interchangeably used with one or more of SSB, CSI-RS, SRS and DM-RS, and still consistent with this disclosure.

Hereafter, time instance may be interchangeably used with slot, symbol, or subframe, and still consistent with this disclosure.

Hereafter, UL-only and DL-only Tx/Rx occasions may interchangeably be used with legacy TDD UL or legacy TDD DL, respectively, and still consistent with this disclosure. In an example, the legacy TDD UL/DL Tx/Rx occasions may be the cases where SBFD is not configured and/or where SBFD is disabled.

Hereafter, an UL signal (e.g., at least one of SRS, DMRS, PUSCH, PUCCH, PRACH, PTRS, etc.) may be used interchangeably with an UL signal or channel, or an UL channel or signal, and still consistent with this disclosure.

Hereafter, a DL signal (e.g., at least one of CSI-RS, SSB, PDSCH, PDCCH, PBCH, PTRS, etc.) may be used interchangeably with a DL signal or channel, or a DL channel or signal, and still consistent with this disclosure.

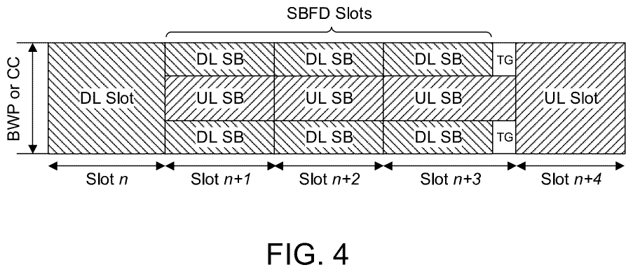

FIG. 4 shows an example SBFD configuration, showing slots in a time domain and bandwidth part (BWP) or component carrier (CC) in the frequency domain. In FIG. 4, slot n is configured as a DL slot and slot n+4 is configured as an UL slot. Slots n+1, n+2, and n+3 are configured as DUD slot. In slot n+3, TG is a time gap for switching, allowing the WTRU/network to switch from transmission to reception, typically before each downlink/uplink switch

A WTRU may be configured with one or more types of slots within a bandwidth. A first type of slot may be used or determined for a first direction (e.g., downlink, or sidelink for example, WTRU-to-WTRU communication, device-to-device communication). A second type of slot may be used or determined for a second direction (e.g., uplink, or sidelink). A third type of slot may have a first group of frequency resources within the bandwidth for a first direction and a second group of frequency resources within the bandwidth for a second direction. Herein, bandwidth may be interchangeably used with bandwidth part (BWP), carrier, sub-band, and system bandwidth. The first type of slot (e.g., the slot for a first direction) may be referred to as downlink (and/or sidelink) slot. The second type of slot (e.g., slot for a second direction) may be referred to as uplink (and/or sidelink) slot. The third type of slot may be referred to as sub-band (non-overlapping or overlapping) full duplex (SBFD) slot, for example, comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)). The group of frequency resources for a first direction may be referred to as downlink (and/or sidelink) sub-band, downlink (and/or sidelink) frequency resource, or downlink (and/or sidelink) RBs. The group of frequency resources for a second direction may be referred to as uplink (and/or sidelink) sub-band, uplink (and/or sidelink) frequency resource, or uplink (and/or sidelink) RBs. The group of frequency resources for a flexible direction (e.g., that may be configured for a first direction, second direction, etc.) may be referred to as flexible sub-band, flexible frequency resource, or flexible RBs. The group of frequency resources between a first direction and a second direction may be referred to as guard band, guard frequency resource, or guard RBs.

In an example, a WTRU may be pre-configured with or receive configuration information regarding one or multiple groups of frequency resources. Some groups of frequency resources may be explicitly configured. Some groups of frequency resources may be implicitly configured. For example, the WTRU may be configured, for example, within a cell or BWP, with a first group of frequency resources assigned to DL and a second group of resources assigned to UL. The WTRU may infer that the remaining group(s) of resources are used as guard bands. The WTRU may receive a configuration including an UL sub-band and a guard band, and infer that the remaining resources are a DL sub-band.

In an example, a (SBFD-enabled) WTRU may receive configuration information or be configured with one or more SBFD UL, DL, sidelink, flexible, and/or guard sub-bands in one or more DL/UL/flexible TDD time instances (e.g., symbols, slots, frames). The WTRU may be configured with one or more resource allocations for SBFD sub-bands.

For example, the SBFD configuration may include a flag signal or indication (e.g., enabled/disabled), where for example a first value (e.g., zero (0)) may indicate a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via, for example, a master information block (MIB), system information block (SIB), RRC, MAC control element (CE), or DCI.

A WTRU may receive information regarding the time resources (e.g., one or more symbols or slots), for which the first mode of operation (e.g., SBFD) is defined in for example one or more BWPs, sub-bands, component carriers (CC), or cells. The WTRU may receive information regarding the frequency resources (e.g., sub-bands/BWPs including one or more physical resource blocks (PRBs)) within (active and/or linked) a BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe) and each bit indication may indicate whether corresponding time instance may be used for the first or second mode of operation.

In an example, a WTRU may be configured with or receive information regarding a DL TDD configuration for a component carrier (CC) or a BWP for one or more Rx occasions (e.g., via tdd-UL-DL-config-common, dedicated configurations, slot format indicator (SFI)). As such, if the first mode of operation (e.g., SBFD) is configured, one or more of the configured frequency resources (e.g., sub-bands, PRBs, and/or BWPs) may be configured for the transmission in UL channels and/or Tx occasions.

In an example, a WTRU may be configured with an UL TDD configuration for a component carrier (CC) or a BWP for one or more Tx occasions (e.g., via tdd-UL-DL-config-common, dedicated configurations, slot format indicator (SFI)). As such, if the first mode of operation (e.g., SBFD) is configured, one or more of the configured frequency resources (e.g., sub-bands, PRBs, and/or BWPs) may be configured as the DL channels and/or Rx occasions.

In an example, a WTRU may be configured with a DL, UL, or flexible TDD configuration for a component carrier (CC) or a BWP for one or more Rx/Tx occasions (e.g., via tdd-UL-DL-config-common, dedicated configurations, slot format indicator (SFI)). As such, if the first mode of operation (e.g., SBFD) is configured, one or more of the configured frequency resources (e.g., sub-bands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, or MAC-CE.

The duplexing mode configuration and/or flag for the first mode of operation (e.g., SBFD) may be configured as part of a resource allocation configuration for a Tx/Rx occasion.

In an example, a WTRU may be configured with one or more types of slots. The WTRU may be configured with a first slot with a first type, where the first type may be for example a SBFD slot. The WTRU may be configured with a second slot with a second type, where the second type may be for example a non-SBFD slot. For the first slot with the first type (SBFD), the WTRU may be configured with one or more DL, UL, flexible, or guard sub-bands in the frequency domain, throughout the BWP, for the duration of the first slot. In the second slot with the second type (non-SBFD), the WTRU may be configured with only one direction type, for example DL, UL, or flexible in the frequency domain, throughout the BWP, for the duration of the second slot.

In an example, if the WTRU is configured with a second slot with an UL direction, this may imply a legacy TDD UL slot, UL-only slot, and/or non-SBFD UL slot. In an example, if the WTRU is configured with a third slot with the second type (non-SBFD) with a DL direction, this may imply a legacy TDD DL slot, DL-only slot, and/or non-SBFD DL slot. In an example, if the WTRU is configured with a fourth slot with the second type (non-SBFD) with a flexible direction, this may imply a legacy TDD flexible slot and/or non-SBFD flexible slot.

In an example, the WTRU may be configured with a SBFD ‘DU’ configuration, referring to a configuration where the upper-frequency sub-band of the cell's carrier is configured as a downlink sub-band, while the lower-frequency sub-band of the same cell's carrier is configured as an uplink sub-band. One or more guard-bands (i.e., unused frequency resources) may be configured at the edge of the cell's carrier or in between sub-bands.

In an example, the WTRU may be configured with a SBFD ‘UD’ configuration, referring to a configuration where the upper-frequency sub-band of the cell's carrier is configured as an uplink sub-band, while the lower-frequency sub-band of the same cell's carrier is configured as a downlink sub-band. One or more guard-bands (i.e., unused frequency resources) may be configured at the edge of the cell's carrier or in between sub-bands.

In an example, the WTRU may be configured with a SBFD ‘DUD’ configuration, referring to a configuration with three sub-bands and both the upper-frequency and lower-frequency sub-band of the cell's carrier is configured as downlink sub-bands, while the middle-frequency sub-band of the same cell's carrier is configured as an uplink sub-band. One or more guard-bands (i.e., unused frequency resources) may be configured at the edge of the cell's carrier or in between sub-bands.

In an example, the WTRU may be configured with a SBFD ‘UDU’ configuration, referring to a configuration with three sub-bands and both the upper-frequency and lower-frequency sub-band of the cell's carrier is configured uplink sub-bands, while the middle-frequency sub-band of the same cell's carrier is configured as a downlink sub-band. One or more guard-bands (i.e., unused frequency resources) may be configured at the edge of the cell's carrier or in between sub-bands.

For a SBFD time-domain configuration, a WTRU may receive configuration information regarding (e.g., may be configured with) SBFD sub-band time locations that may be configured within a period. In an example, the period may be the same as a TDD-UL-DL pattern period configured by, for example, dl-UL-TransmissionPeriodicity (e.g., in TDD-UL-DL-ConfigCommon). In an (e.g., another) example, the period may be an integer multiple of the TDD-UL-DL pattern period configured by dl-UL-TransmissionPeriodicity (e.g., in TDD-UL-DL-ConfigCommon).

When a (e.g., one, only one) TDD-UL-DL pattern is configured, SBFD symbols may be configured in a consecutive manner within a TDD-UL-DL pattern period. When two TDD-UL-DL patterns are configured and if SBFD symbols are configured for only one of the patterns, SBFD symbols may be configured in a consecutive manner within the TDD-UL-DL pattern period. When two TDD-UL-DL patterns are configured and if SBFD symbols are configured for both patterns, SBFD symbols may be configured in a consecutive manner within each TDD-UL-DL pattern period.

For dynamic SBFD configuration, a WTRU may be configured with or receive configuration information regarding one or more SBFD configurations, changing over time. The WTRU may receive multiple configurations for different SBFD patterns, such as one or more DU, UD, DUD or UDU patterns. The WTRU may receive the configuration to apply a time pattern where different of these SBFD configurations are used over time. In an example, the period may be the same as a TDD-UL-DL pattern period configured by, for example, dl-UL-TransmissionPeriodicity (e.g., in TDD-UL-DL-ConfigCommon). In an (e.g., another) example, the period may be an integer multiple of the TDD-UL-DL pattern period configured by dl-UL-TransmissionPeriodicity (e.g., in TDD-UL-DL-ConfigCommon).

A WTRU may be configured with a dedicated SBFD configuration, where the WTRU receives, for example, via RRC dedicated signaling, the SBFD configuration to apply for selected time resources. This may apply the same pattern and periods as an RRC (re)configuration TDD-UL-DL-ConfigDedicated field.

A WTRU may be configured with multiple (serving) cells, for example, for Carrier Aggregation (CA), and in the case of a dynamic SBFD configuration, the WTRU may be configured with different SBFD configuration at the same time across different cells.

In the network, geographically neighboring cells (that may be controlled by different gNBs or nodes) may be configured with independent SBFD configuration, for example, using different SBFD patterns and/or different sub-band size and position configurations. The network may be able to exchange information about the configuration of the different cells between gNBs.

A WTRU may determine (or be indicated/configured with) that ‘UL usable PRBs’ are a part of UL sub-band frequency resources within an UL BWP (e.g., an active UL BWP, a currently active UL BWP), and ‘DL usable PRBs’ are a part of DL sub-band frequency resources within an DL BWP (e.g., an active DL BWP, a currently active DL BWP). The UL usable PRBs may be determined as an intersection between a configured or indicated UL sub-band and an active UL BWP in SBFD symbols (and/or slots). The DL usable PRBs may be determined as an intersection between a configured or indicated DL sub-band(s) and an active DL BWP in SBFD symbols (and/or slots). In an (e.g., another) example, the UL and/or DL usable PRBs may be explicitly configured within active UL and/or DL BWP (e.g., in SBFD symbols and/or slots).

In an example, a WTRU may receive information for frequency resource allocation (e.g., Type 0 as RBG-level bitmap-based resource assignment) for a PDSCH or PUSCH (as being scheduled) in a slot(s). When an assigned RBG overlaps with a sub-band boundary, the WTRU may determine that (only) the PRBs within DL usable PRBs are to be valid for PDSCH reception and (only) the PRBs within UL usable PRBs are to be valid for PUSCH transmission, for example, where this may imply “partial RBG” is allowed and valid for resource allocation.

A WTRU may receive configuration information (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs an UL transmission or a DL reception (not both simultaneously at the given time). The WTRU may (also) operate in an FD mode for communicating with the gNB, for example, if a corresponding WTRU capability signal(s) or information is reported to the gNB and/or the WTRU receives a confirmation message (e.g., enabling the FD, configuring the FD mode) in response to transmitting the WTRU capability signal(s) or information.

The FD operation may imply at a given time a transmitter (e.g., the gNB and/or the WTRU) may simultaneously transmit a first signal (or message) and receive a second signal (or message). The FD operation may comprise a subband overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within a configured SBFD subband, for example, DL subband, usable DL PRBs) does not have an overlap with a second frequency-domain resource allocated for the second signal (e.g., assigned within a configured SBFD subband, for example, UL subband, usable UL PRBs).

Hereafter, for the brevity of discussion, the FD operation may comprise the SBFD operation, however the embodiments and examples in the disclosure may equally (or equivalently or extendedly) be employed (e.g., applicable) for cases with other FD operation types (e.g., IBFD).

A WTRU may receive SBFD-related configuration(s), for example, for frequency-domain location information of one or more subbands (e.g., DL subband, UL subband, flexible DL/UL subband, and/or guard band), and/or for time-domain location information of the one or more subbands. The time-domain location information may indicate a set of non-SBFD symbols and a set of SBFD symbols (e.g., as shown in FIG. 4). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit an UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, for example, depending on one or more conditions with other signal(s) co-existing in the symbol(s).

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least a rank indicator (RI), channel quality indicator (CQI), precoding matrix indicator (PMI), or Layer Index (LI).

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, or cell switching.

A WTRU may measure and report the channel state information (CSI), wherein the CSI for each connection mode may include or be configured with one or more of following.

The CSI for each connection mode may include a CSI report configuration, including one or more of the following: CSI report quantity (e.g., Channel Quality Indicator (CQI), Rank Indicator (RI), Precoding Matrix Indicator (PMI), CSI-RS Resource Indicator (CRI), Layer Indicator (LI)); CSI report type (e.g., aperiodic, semi persistent, periodic); CSI report codebook configuration (e.g., Type I, Type II, Type II port selection); and CSI report frequency.

The CSI for each connection mode may include a CSI-RS resource set, including one or more of the following CSI resource settings: NZP-CSI-RS resource for channel measurement; NZP-CSI-RS resource for interference measurement; and CSI-IM resource for interference measurement.

The CSI for each connection mode may include NZP CSI-RS resources, including one or more of the following: NZP CSI-RS resource ID; periodicity and offset; QCL information and TCI-state; and resource mapping (e.g., number of ports, density, CDM type).

A WTRU may indicate, determine, or be configured with one or more reference signals. The WTRU may monitor, receive, and measure one or more parameters based on the respective reference signals. For example, one or more of the following may apply. The following parameters are non-limiting examples of the parameters that may be included in reference signal(s) measurements. One or more of these parameters may be included. Other parameters may be included.

The WTRU may indicate, determine, or be configured with a synchronization signal reference signal received power (SS-RSRP). The SS-RSRP may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

The WTRU may indicate, determine, or be configured with a CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

The WTRU may indicate, determine, or be configured with a synchronization signal signal-to-noise and interference ration (SS-SINR). The SS-SINR may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

The WTRU may indicate, determine, or be configured with CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

The WTRU may indicate, determine, or be configured with a received signal strength indicator (RSSI). The RSSI may be measured based on the average of the total power contribution in configured OFDM symbols and bandwidth. The power contribution may be received from different resources (e.g., co-channel serving and non-serving cells, adjacent channel interference, thermal noise).

The WTRU may indicate, determine, or be configured with a cross-Layer interference received signal strength indicator (CLI-RSSI). The CLI-RSSI may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise). In the case where L1-CLI-RSSI is used, the WTRU may not perform L3 filtering over multiple measurement samples, which may help identify time bursts of interferences.

The WTRU may indicate, determine, or be configured with a sounding reference signals RSRP (SRS-RSRP). The SRS-RSRP may be measured based on the linear average over the power contribution of the resource elements (RE) that carry the respective SRS. In the case where L1-SRS-RSRP is used, the WTRU may not perform L3 filtering over multiple measurement samples, which may help identify time bursts of interferences.

A WTRU may be configured, determined, or indicated to perform a measurement of cross-link interference (CLI) Received Signal Strength Indicator (RSSI) in a given time period. The given time period may be one or more slots, OFDM symbols, resource blocks (RBs), and/or resource elements (Res). The CLI-RSSI which may be measured in a given time and/or frequency resource may be referred to as L1-CLI-RSSI, short-term CLI-RSSI, or aperiodic CLI-RSSI. The WTRU may be configured, determined, or indicated to perform a measurement of Reference Signal Received Power (RSRP) based on one or more reference signals (e.g., SRS-RSRP) in the context of CLI measurement in a given time period. The given time period may be one or more slots, OFDM symbols, resource blocks (RBs), and/or resource elements (Res). The SRS-RSRP which may be measured in a given time and frequency resource may be referred to as L1-SRS-RSRP, short-term SRS-RSRP, aperiodic SRS-RSRP, or SRS-RSRP-CLI.

Herein, the terms CLI-RSSI, L1-CLI-RSSI, and RSSI may be interchangeably used and still consistent with the disclosure. Herein, the terms SRS-RSRP, SRS-RSRP-CLI, L1-SRS-RSRP, and RSRP may be interchangeably used and still consistent with the disclosure.

One or more RSSI (or RSRP) types or measurement configurations may be used and a WTRU may be configured to perform one or more RSSI (or RSRP) measurement configurations. A first RSSI (or RSRP) type or measurement configuration may be based on a measurement over a long time period (e.g., more than one slot) (e.g., L3 measurements) and the measurement may be reported via a higher layer signaling (e.g., RRC, MAC). A second RSSI (or RSRP) type or measurement configuration may be based on a measurement over a short time period (e.g., one slot, within a slot, one or more OFDM symbols within a slot) (e.g., L1 measurements) and the measurement may be reported via an L1 signaling (e.g., PUCCH, PUSCH, RACH, SRS). RSSI may be interchangeably used with RSRP, RSRQ, and SINR. CLI-RSSI may be interchangeably used with SRS-RSRP and SINR.

A WTRU may be configured with one or more sets of time and frequency resources for measuring CLI (e.g., SRS-RSRP) (e.g., a new IE SRS-RSRP-MeasurementResourceSet) comprising one or more sets of configuration information of SRS-RSRP measurement resource(s) (e.g., SRS-RSRP-MeasurementResource), for example for L1 SRS-RSRP measurement. The SRS-RSRP measurement resource configurations may include, for example, one or more of: a number of SRS ports; transmission comb; time resource mapping such as start position; number of symbols; repetition; frequency resources; frequency hopping; resource type such as periodic, aperiodic, or semi-persistent; and/or sequence ID used for SRS.

A WTRU may be configured with one or more sets of time and frequency resources for measuring CLI (e.g., CLI-RSSI) (e.g., a new IE CLI-RSSI-MeasurementResourceSet) comprising one or more sets of configuration information of CLI-RSSI measurement resource(s) (e.g., CLI-RSSI-MeasurementResource), for example for L1 CLI-RSSI measurement. The CLI-RSSI measurement resource configurations may include, for example, one or more of: CLI-RSSI measurement resource ID, starting PRB index, number of PRBs, starting symbol of the CLI-RSSI resource within a slot, number of symbols of the CLI-RSSI resource within a slot, and/or periodicity and slot offset for the CLI-RSSI resource.

Hereafter, for the brevity of discussion, the CLI measurement may comprise the CLI-RSSI measurement, however the embodiments and examples in the disclosure may equally (or equivalently or extendedly) be employed (e.g., be applicable) for cases with other interference and/or CLI measurements (e.g., SRS-RSRP or CLI-RSRP).

A WTRU may be configured with a set of time and frequency resources to measure L1-CLI-RSSI, wherein the time and frequency resources for L1-CLI-RSSI measurement may be referred to as CLI-RSSI Measurement Resource (CRMR).

CRMR may be a resource configured, determined, or defined (e.g., via RRC, MAC-CE, DCI) (e.g., via CLI-ResourceConfig, CLI-ResourceConfig-r-16) with one or more of following properties.

CRMR may comprise a set of muted resource elements (REs) in a downlink resource (e.g., PDSCH). The muted Res may be rate-matched around or punctured for downlink reception and/or uplink transmission. The set of muted Res may have a same pattern (e.g., same time and frequency location) in each RB. The set of muted Res may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted Res. The muted Res may be in a form of zero-power resources (e.g., CSI-RS and/or ZP-CSI-RS).

CRMR may comprise a set of Res not scheduled or used for the WTRU measuring CRMR.

CRMR may comprise a set of Res that may be located in an RB which may be configured or determined as a guard band (or guard RB). A guard band (or guard RB) may be located in between uplink and downlink resources. A WTRU may skip receiving or transmitting a signal in a guard band.

CRMR may comprise one or more reference signals (e.g., DMRS, SRS, sidelink CSI-RS).

CRMR may comprise a second set of DMRS REs within a second code division multiplexing (CDM) group (e.g., within a scheduled downlink resource and/or RBs, for example, of a PDSCH), where a WTRU may receive a DCI, scheduling a PDSCH, indicating a first set of DMRS Res corresponding to a first CDM group to be used for receiving the PDSCH. In an example, the WTRU may receive the DCI, scheduling the PDSCH, indicating a first set of DMRS Res corresponding to a first CDM group (based on an indicated ‘(DMRS) antenna port’ field of the DCI). In response to receiving the DCI, the WTRU may determine that a second set of DMRS Res within a second CDM group (other than the first CDM group) may be used as the CRMR (e.g., within the scheduled PDSCH).

CRMR may be located within a scheduled resource (e.g., scheduled PDSCH RBs).

CRMR may be configured commonly for a set of WTRUs (e.g., WTRUs in proximity). For example, a gNB may configure a CRMR for a group of WTRUs, wherein the group of WTRUs may share one or more of following: a group-ID to receive a DCI (e.g., a group-RNTI); a zone-ID, wherein the zone-ID may be determined based on a geographical location of the WTRU (e.g., Global Navigation Satellite System (GNSS)); and/or WTRUs paired for sidelink unicast (or groupcast) transmission.

L1-CLI-RSSI measurement (including a CRMR resource) may be considered as CSI reporting quantity and configured as a part of a CSI reporting setting.

CRMR may be configured in a first subband type (e.g., DL subbands) to measure the (effect of) one or more reference signals received in a second subband type (e.g., UL subbands). As such, the reference signals may be received and measured in resources that may be identified as zero-power or muted resources. A WTRU may be configured, determined, or indicated to measure the effect of reference signals being transmitted in other resources (e.g., second type resources, for example, UL subbands) in these resources (e.g., first type resources, for example, DL subbands). For example, a first WTRU may be configured to measure SRS-RSRP in DL subbands on an SBFD configuration, where the SRS is transmitted by a second WTRU in the UL subbands. In an example, the first WTRU may measure SRS-RSRP based on the configured SRS signaling in the DL subbands. In another example, the WTRU may measure the CLI-RSSI based on the configured SRS signaling in the UL subbands.

A WTRU may be configured, determined, or indicated to perform a delta CLI-RSSI, which may be based on a first CLI-RSSI measurement in a first time and/or frequency location and a second CLI-RSSI measurement in a second time and/or frequency location. One or more of following may apply.

The delta CLI-RSSI (delta-CLI-RSSI) may be a difference between a first CLI-RSSI (e.g., CLI-RSSI1) and a second CLI-RSSI (e.g., CLI-RSSI2), for example, delta-CLI-RSSI=CLI-RSSI1−CL-RSSI2 (or delta-CLI-RSSI=CLI-RSSI2−CL-RSSI1).

The first CLI-RSSI may be measured from CRMR resources located in the edge of the scheduled RBs while the second CLI-RSSI may be measured from CRMR resources located in the middle of the scheduled RBs.

A WTRU may be configured with a first CRMR resource for the first CLI-RSSI measurement and a second CRMR resource for the second CLI-RSSI measurement.

A WTRU may determine to report CLI measurement related information when a measured delta-CLI-RSSI is larger than a threshold value. For example, CLI reporting may be triggered based on delta-CLI-RSSI measurement being larger than a threshold value. The threshold value may be predetermined or configured.

For bandwidth and/or subband configuration for CLI measurement, a WTRU may be configured or determine to measure CLI-RSSI per subband level. For example, a subband may be configured or predetermined and a WTRU may perform CLI-RSSI measurement in each subband. One or more of following may apply. A subband size may be determined based on the number of scheduled RBs (e.g., for PDSCH). The WTRU may report CLI-RSSI measurement for all subbands. The WTRU may report a subset of CLI-RSSI, wherein the subset may be determined based on one or more conditions (e.g., CLI-RSSI value above a threshold value, subband location (e.g., edge of scheduled RBs), and/or subband index).

A WTRU may determine a bandwidth of beam measurement and/or reporting (e.g., wideband or subband) based on one or more of the following conditions. The WTRU may determine a bandwidth of beam measurement and/or reporting based on a time unit type (e.g., SBFD or non-SBFD). For example, a WTRU may report wideband CRI (e.g., wideband beam index) in non-SBFD time units (e.g., symbol, slot) and the WTRU may report subband CRI (e.g., subband beam index) in SBFD time units. The WTRU may determine a bandwidth of beam measurement and/or reporting based on a presence of CLI-RSSI measurement. The bandwidth of beam measurement/reporting may be determined based on whether CLI-RSSI is measured in the same slot or not.

A WTRU may be indicated to perform CLI-RSSI measurement in a specific frequency location within a scheduled RBs (or non-scheduled RBs). The specific frequency location may be one or more of: subbands, RBs, and/or Res. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform a measurement on a CRMR resource indicated in a DCI.

Hereafter, wordings such as “the WTRU is configured”, “the WTRU is preconfigured”, “the WTRU receives a configuration”, “the WTRU receives a pre-configuration”, may be interchangeably used, meaning that the WTRU receives an indication from the network, either from RRC (re)configuration, MAC indication, DCI signaling or MIB/SIB indication, which may be explicit or implicit, based on the specification, or that the WTRU has an internal setting or default setting of the configuration without additional network signaling.

Hereafter, when a WTRU is using a parameter value such as a threshold for determination of whether a condition is met or not, the WTRU may be assumed to have received the (pre)configuration of the corresponding threshold beforehand, for example, from the network.

A WTRU may generate interferences (CLI) to another WTRU. The WTRU that generates CLI may be referred to as a ‘first’ WTRU, for example, as shown in FIG. 2 and FIG. 3. Reciprocally, a WTRU that receives the interference (CLI) may be referred to as a ‘second’ WTRU, for example as shown in FIG. 2 and FIG. 3.

In an embodiment, if a WTRU is capable of SBFD or FD operations, the first WTRU, that may cause interference and the second WTRU, that may receive interference, may be the same WTRU, and the CLI becomes self-Interference or self-interference leakage.

Although the present disclosure focuses on SBFD operations for 5G and 5G advanced, similar procedure may apply on other duplexing systems that may introduce CLI from a WTRU to another WTRU, such as 6G, for example, for dynamic TDD/SBFD, in-band/overlapping full duplex, XDD, and WTRU-based SBFD.

Although the present disclosure focuses on UL SRS detection and transmission for 5G and 5G advanced, similar procedure and behavior may apply on other signals that can be transmitted by a WTRU and received by another WTRU, for example, any UL RS (e.g., phase tracking reference signal (PT-RS), demodulation reference signal (DMRS), or any RS applicable for CLI mitigation/handling method discussed throughout the disclosure), SL RS (e.g., SL SSB, SL DMRS, SL CSI-RS) or similar detectable signals.

A WTRU may receive a configuration (e.g. pre-configured or configuration information) for SRS detection associated with a transmission.

In an embodiment, a WTRU may receive an indication from the network indicating the configuration(s) for the measurement/monitoring/detection of WTRU-transmitted signals, for example, a reference signal (e.g. an UL SRS, UL PTRS, UL DMRS, SL CSI-RS, SL SSB, or SL DMRS). The measurements are intended to be configured so that the WTRU may be able to measure/detect one or more transmissions from other WTRUs (i.e., the configuration corresponds to configurations sent to other WTRUs (e.g., a similar mapping (association) and resource configuration).

The (pre)configuration may include at least the format and the resources on which to perform monitoring the signal detection.

The WTRU may receive a configuration for one or more resources for WTRU transmitted signal measurements. The resources may be UL resources (i.e., in an UL band or subband, or resources that may be configured for UL transmissions). The UL resources may be on SBFD slots/symbols, non-SBFD symbols/slots, FD, XDD or any duplexing resources. The resources may be on resources for WTRU to WTRU communications, for example, on SL resources such as SL resource pools, or any resources that the WTRU may use or be configured to use for WTRU to WTRU transmissions. The resources may be on resource without a dedicated or configured duplexing direction, for example, for technologies where the duplexing is flexible, (dynamically) configurable and/or where the transmission and reception resources may overlap, at either the network or the WTRU side. The resources may be configured as periodic resources or semi-persistent resources, where a periodicity parameter is given or provided to the WTRU. If the resource is semi-persistent, the resource may be activated or deactivated via a received further indication, for example, by MAC/DCI indication. The resources may be configured using a mapping/association or a reference to a previous event or based on the transmission resource patterns, for example, where the resources to monitor is following the UL transmissions resources. For example, similarly with a HARQ feedback resource mapping, a monitoring resource may be configured with respect to UL resources.

In an example, the WTRU may receive the configuration of the RS to detect/monitor, for example, a SRS. One advantage of the SRS is that the current standard already supports that WTRUs measure other WTRUs' SRS for CLI measurement, reducing the impact on other WTRUs.

In an example, the SRS configuration may include one or more SRS resources. The SRS resources may be grouped into one or more SRS resource sets. The configuration may include information for each resource or resource set. For example, the configuration may include information regarding or indicating time resources, for example, the slots and/or symbols on which the SRS is expected (e.g., based on a resource mapping/association with a starting position, number of symbols, or repetition factor). The configuration may include information regarding or indicating a periodicity. The resource may be aperiodic, periodic or semi-persistent. If the resource is periodic or semi-persistent, the configuration may further include a period parameter, for example, as a number of slots or as a time periodicity in, for example ms. The configuration may include information regarding or indicating a usage indication. In an example, the usage may be set to ‘measurement’ or an indication of CLI measurement/detection. The configuration may include information regarding or indicating frequency resources, for example, the frequency resource elements of the SRS, (e.g., based on a frequency position, shift, hopping and/or which may be contiguous or non-contiguous, for example, based on a comb parameter). The configuration may include information regarding or indicating a sequence or sequence index, which may be used to determine the transmitted signal. The configuration may include information regarding or indicating an SRS index and/or SRS resource set index. The configuration may include information regarding or indicating beam indication, for example, for how the WTRU is to configure its spatial transformation to receive the SRS (e.g., as a spatial relation information, TCI state, reference RS, and/or a beam index).

For other existing RS, the WTRU may similarly receive the configuration parameters associated to the RS, for example, formats, sequence indices, and/or time/frequency resources based on the configured RS.

The WTRU may receive the configuration to perform a different action/processing of the signal reception. For example, the WTRU may be configured to perform a measurement, for example, an SRS measurement, with an indication of the measurement metrics (e.g., based on RSRP (e.g. L1-SRS-RSRP, SRS-RSRP), RSSI (e.g., L1-CLI-RSSI, CLI-RSSI), or SINR (L1-SINR, SINR)). The WTRU may be configured to perform a detection, for example, where the WTRU is configured to detect the presence of a signal on the configured resource (e.g., if the signal strength is above a configured threshold value). The WTRU may be configured to perform an identification, for example, where the WTRU is configured to detect and identify one or more specific signals in that resource (e.g., based on a resource index, sequence index, and/or WTRU index).

In this disclosure, the wording of the configured action of measurement/detection/monitoring/identification may be used interchangeably unless specified otherwise.

The WTRU may receive the configuration for the SRS measurement/detection/monitoring using, for example, RRC signaling (e.g., via an IE dedicated to CLI management or SRS detection/monitoring) or MAC signaling (e.g., via a dedicated MAC CE message and/or DCI indication).

The WTRU may receive a reporting configuration associated with the SRS measurement or the SRS resource(s). The reporting configuration may include, for example, the resources and format on which to transmit the report. For example, the WTRU may be configured with UL resources to transmit a report using uplink control information (UCI). For example, the WTRU may be configured to transmit the reporting using an UL MAC CE, and may receive one or more grants or (semi)periodic grants to transmit the corresponding report. The reporting configuration may include a timing of the report. The WTRU may be configured to perform the reporting associated with a transmission-triggered SRS measurement based on a timing (e.g., time offset) or mapping/association between the UL transmission (e.g., UL transmission resources) or the SRS measurement resources and the report. The reporting configuration may include conditions. The WTRU may receive conditions and configuration on how/what to report. For example, the WTRU may be configured to report for example: only resources that are above a measurement threshold value (e.g., based on (L1-) RSRP, RSSI or SINR values); resources with the strongest and/or weakest received signals; and/or a maximum number of resources to report

In an embodiment, the WTRU may transmit to the network its capabilities (e.g., via RRC or MAC signaling), where the capabilities, related to SRS measurements and transmission-triggered measurements may include one or more of the following. The capabilities may include support of the feature. For example, the WTRU may indicate to the network whether it supports the transmission-triggered SRS measurements. The capabilities may include timing requirements. For example, the WTRU may indicate the minimum or maximum delay between a transmission and the associated measurement. The capabilities may include measurement/detection capabilities. For example, the WTRU may indicate how many signals (e.g. SRS) the WTRU may be able to process at once or in a given time duration (e.g., simultaneously over the same and/or different time/frequency resources) or for a given transmission. The WTRU may be limited by hardware or processing capability on how many signals to receive/detect and this indication may guide the network to prepare the appropriate configurations for this WTRU and other WTRUs.

In an example, the WTRU may receive the configuration of the SRS resources so that each SRS transmission/reception corresponds to an indication allowing to identify a WTRU experiencing CLI. The resources may be individually configured as a signature for each other (second) WTRUs, and/or for each (first) WTRU. The association between WTRUs and their corresponding resource is typically managed by the network and may use different parameters of the SRS resources (e.g., individual sequence ID, time or frequency resources, and/or patterns)

The (first) WTRU may receive the association between a resource and the corresponding (second) WTRU, for example, via a WTRU ID indication mapping to the resource.

The (first) WTRU may also not receive indications about the specific WTRU the resource associates to, to keep an anonymous reporting to preserve the confidentiality of the other WTRUs. The WTRU may receive an ID (e.g., a partial WTRU ID, a temporary ID, a mock ID or a random ID), for which the network knows the association to the actual WTRU ID.

The WTRU may receive a configuration associating an SRS measurement (e.g., a measurement configuration, a reporting configuration, and/or one or multiple SRS resources) with an (UL) transmission. For example, the WTRU may be configured to perform/trigger an SRS measurement and reporting on a configured SRS resource after performing a transmission. The configuration of the association may include one or more of the following examples.

The configuration of the association may include a configuration for mapping/association. The WTRU may receive the mapping configuration between a transmission (i.e. the UL transmission resources), and the transmission-triggered SRS measurement resource. The mapping may be, for example, based on at least one of following.

The transmission-triggered SRS measurement resources mapping may be configured as a one-to-one mapping, (i.e., for each time/frequency resource of the UL transmission, a corresponding SRS resource exists). This has the advantage of being easy to identify for the WTRUs and a WTRU monitoring that resource would be able to directly associate and determine the transmission corresponding to an SRS reception, however, it may require a lot of resources.

The transmission-triggered SRS measurement resources mapping may be configured as a many-to-one mapping (i.e., multiple time/frequency resources of the UL transmission may correspond to one SRS resource). This has the advantage of regrouping resources to cost less overhead but it may create ambiguity in the identification of the SRS.

The transmission-triggered SRS measurement resources mapping may be configured as a one-to-many mapping (i.e., one time/frequency resource of the UL transmission may correspond to multiple SRS resources).

In an example, the WTRU may receive the configuration where multiple SRS resources are associated with a given transmission, each SRS resource being associated with a different sequence index and/or time/frequency resources. This may be used, for example, by the network to configure multiple WTRUs to perform the SRS transmissions corresponding to the triggering-transmissions.

In an example, this may allow a better reliability and redundancy of the SRS at the cost of increased overhead resources, for example, with different SRS transmission/reception parameters such as beams, to be able to reach WTRUs in different areas.

The transmission-triggered SRS measurement resources mapping may be configured as a time and/or frequency offset with respect to the time/frequency resources of the UL transmission, for example, offsets as a number of symbols/slots and as a number of REs/RBs.

The transmission-triggered SRS measurement resources mapping may be configured within a set of transmission-triggered SRS measurement resources. The different SRS resources may be identified and differentiated by, for example, their time, frequency, code, sequence index, and/or shift, and may be assigned with different indices, each corresponding to a possible UL transmission resource. This would be beneficial to regroup all of the SRS resources in a limited time/frequency resource area for monitoring.

At least one method of the above transmission-triggered SRS measurement mapping may be applied separately (e.g., independently, differently, based on corresponding configuration/indication) for different transmission configurations. For example, a transmission configuration may be per channel or signal (e.g., PUCCH, PUSCH, SRS, PSCCH, PSSCH, PRACH), and/or per channel or signal's type (e.g., Type1-CG-PUSCH, Type2-CG-PUSCH, DG-PUSCH, PUCCH for CSI reporting, PUCCH with HARQ-ACK, and so on, based on configuration or indication).

For example, a transmission configuration may be per transmission beam (e.g., per configured TCI, QCL, associated RS, or beam index configured for the transmission). Since the transmission beam impacts the WTRUs that will suffer from CLI, it may be beneficial to have separated groups of WTRUs and their associated SRS resources to measure for different transmission beams.

For example, a transmission configuration may be per transmission resource (e.g., depending on whether the transmission is configured on SBFD/FD resources or non-SBFD/non-FD resources, or depending on the timing of the resources).

In an example, the WTRU may receive a configuration indicating SRS resources that are periodic or semi-periodic, and the WTRU may determine, based on time/frequency offset or mapping indications, the SRS resource(s) that corresponds to the next periodic SRS occasion, for example, the mapping may be a time offset between a transmission and a minimum SRS resource time resource, and the WTRU may determine that the SRS resource associated with the transmission is the first following a periodic SRS resource after the UL transmission time plus the time offset.

In an example, the WTRU may receive a configured SRS resource configuration that is aperiodic and may determine the SRS resource based on the indicated time/frequency offset or mapping, and may use the aperiodic configuration in the time of the UL transmission plus the time offset.

The mapping configuration may be received using, for example, RRC signaling, and may be applicable to the following transmissions, or applicable to a configured periodic/semi-periodic transmission grant corresponding.

The mapping configuration may be received using, for example, MAC signaling (e.g., for (de)activation and/or modification of the mapping, or applicable to a configured semi-periodic transmission grant).

The mapping configuration may be received using, for example, DCI/PHY-level indication (e.g., jointly with a grant, applicable to a the dynamic/aperiodic transmission grant).

There are different ways the WTRU may be triggered/configured to determine the resources and measure configured SRS resource(s). In one common aspect of this disclosure, the WTUR may be triggered/configured to measure SRS following an (UL) transmission.

A WTRU may determine to measure an SRS after an UL transmission.

In an embodiment, the WTRU may be (pre)configured with a set of SRS measurement resources, e.g., (semi-) periodic resource on which to perform the transmission-triggered SRS measurement. The WTRU may be (pre)configured with a mapping rule or association between an UL transmission and a resource from the set of SRS resources. After the WTRU performs an UL transmission, the WTRU may determine if the transmission triggers the measurement of an SRS based on UL transmission conditions (e.g., being in SBFD resources). The WTRU may determine the SRS resources based on, for example, the mapping and the performed UL transmission. The WTRU may perform the measurement on the determined SRS resources.

The WTRU may receive one or more or a combination of the following. The WTRU may receive a configuration indicating the (de)activation (e.g., deactivation and/or activation) of the feature. Upon reception of the transmission-triggered SRS measurement activation, the WTRU may start the transmission-triggered SRS measurement. Upon reception of the transmission-triggered SRS measurement deactivation, the WTRU may stop measuring the transmission-triggered SRS measurement resources. The WTRU may receive the (de)activation indication explicitly or implicitly.

In an example, the WTRU may receive the configuration for the feature (e.g., the configuration for the SRS resources associated with transmissions, or the mapping/association between the UL transmission and the SRS resource. Based on receiving the configuration, the WTRU may assume that the feature is activated.

In an example, the WTRU may receive a configuration for transmission-triggered SRS measurement resources that are semi-persistent. The (de)activation may be, for example, via RRC signaling, MAC signaling (e.g., MAC CE), and/or DCI, and may implicitly indicate the (de)activation of the transmission-triggered SRS measurement.

In an example, the WTRU may receive an explicit indication for (de)activation of the feature, for example, via RRC signaling, MAC CE, and/or a DCI indication.

In an example, the WTRU may receive an explicit indication for activation and/or deactivation of the feature by a multicast, or broadcast, signaling transmitted to a group of WTRUs, for example, via a group-common DCI such as DCI format 2_0. This may provide benefits in that the network may turn ON or OFF of this feature WTRU-group-specifically, based on an overall CLI level in a cell area.

A WTRU may be triggered by the network to perform SRS measurement after a transmission.

In an embodiment, the WTRU may be (pre)configured with a set of SRS resources, for example, (semi-) periodic resources on which to perform the transmission-triggered SRS measurement. The WTRU may be (pre)configured with a mapping rule or association between an UL transmission and a resource from the set of SRS resources. The WTRU may then receive an UL transmission command from the network (e.g., dynamic or configured grant) including an indication to perform the transmission-triggered SRS measurement resource for that transmission, using the (pre)configured mapping.

In an example, the WTRU may be configured with (semi-)periodic transmissions, for example, via RRC signaling and/or MAC (de)activation signaling. The (semi-)periodic transmissions configuration may include an indication that these transmissions trigger an associated SRS measurement, for example, using a flag or a binary parameter. When the WTRU performs the transmission(s) corresponding to these configured transmissions, the WTRU is triggered to perform the associated SRS measurement.

In an example, the WTRU may receive a DCI granting an UL transmission and the DCI may include an (e.g. flag/binary) indication for the WTRU to trigger the SRS measurement associated with that transmission.

In an embodiment, the WTRU may be (pre)configured with a set of SRS resources, for example, (semi-) periodic resource(s) on which to perform the transmission-triggered SRS measurement. The WTRU may then receive an UL transmission command from the network (e.g., dynamic or configured grant) including an indication of the SRS resource(s) to monitor.

In an example, the WTRU may be configured with (semi-)periodic transmissions, for example, via RRC signaling and/or MAC (de)activation signaling. The (semi-)periodic transmissions configuration may include an indication that these transmissions trigger an SRS measurement and a mapping indication to one of the configured SRS measurement resources, for example, using an index or offset, a delay between the transmission and a SRS measurement resource or a resource assignment targeting. When the WTRU performs the transmission(s) corresponding to these configured transmissions, the WTRU is triggered to perform the transmission-triggered SRS measurement on the indicated resources.

In an example, the WTRU may receive a DCI granting an UL transmission and the DCI may include a mapping indication to one of the configured SRS measurement resources, for example, using an index or offset, a delay between the transmission and a SRS measurement resource or a resource assignment targeting. When the WTRU performs the transmission(s) corresponding to these configured transmissions, the WTRU is triggered to perform the transmission-triggered SRS measurement on the indicated resources.

In an embodiment, the WTRU may receive an SRS measurement resource, for example, a aperiodic SRS measurement resource and an UL transmission command from the network (e.g., dynamic or configured grant), jointly or separately, indicating that the SRS resource may be monitored for that UL transmission.

In an example, the WTRU may be configured with (semi-)periodic transmissions, for example, via RRC signaling and/or MAC (de)activation signaling. The (semi-)periodic transmissions configuration may include an indication that these transmissions trigger an SRS measurement and a mapping rule or association to indicate the SRS measurement resources to monitor, for example, using a delay or a resource assignment, or a time/frequency rule between the UL transmission and a SRS measurement resource. When the WTRU performs the transmission(s) corresponding to these configured transmissions, the WTRU is triggered to perform the transmission-triggered SRS measurement on the indicated resources.

In an example, the WTRU may receive a DCI granting an UL transmission and the DCI may include a mapping indication to a SRS measurement resource, for example, using an index or offset, a delay between the transmission and a SRS measurement resource, or a direct resource assignment for SRS measurement resource (e.g., indicating the time and frequency position of the SRS resource dynamically). When the WTRU performs the transmission(s) corresponding to these configured transmissions, the WTRU is triggered to perform the transmission-triggered SRS measurement on the indicated resources.

In an example, the WTRU may also be indicated, jointly with the transmission assignment and SRS measurement configuration, with a corresponding reporting configuration (e.g., reporting resource or timing between the transmission/measurement and the report).

In a complementary example with previous points, the WTRU may receive an indication from the network to perform an SRS measurement following an UL transmission (dynamic or (semi-) persistent, where the indication is a subset of the configured SRS resource(s). The WTRU may then be configured to perform the measurement on the indicated SRS resources and/or may be configured to further determine the SRS resource(s) to perform SRS measurement based on both the indicated subset of resource and configured time/frequency/mappings indications.

A WTRU may determine whether to measure SRS based on transmission criterions.

In an embodiment, to avoid large overhead or systematic measurements of SRS, the WTRU may receive a configuration to determine whether to perform an SRS measurement after an UL transmission based on conditions. The WTRU may receive the condition configuration, for example, which conditions and the corresponding parameters (e.g., thresholds, through RRC, MAC or DCI signaling). The criterion-based determination is applicable to both “WTRU determined SRS measurement” or “network-triggered SRS measurements”. Conditions may include one, more or a combination of the following.

A condition may include SBFD resources. The WTRU may determine to perform the transmission-triggered SRS measurement if the UL transmission is in full duplex (FD) (e.g., SBFD) symbols/slots. SBFD-related CLI mainly impact other WTRUs when the transmission is in FD (e.g., SBFD) resources.

In an example, the WTRU may be configured to perform the transmission-triggered SRS measurement when (whenever) it has an UL transmission in a SBFD slot/symbol.

In an example, the WTRU may be configured to perform the transmission-triggered SRS measurement when (whenever) it has an UL transmission in a selected subset of SBFD slot/symbol configuration, for example, restricted to any subset of the possible SBFD configurations {DU, DUD, UD, UDU}.

In an example, the WTRU may be configured to perform the transmission-triggered SRS measurement when (whenever) it has an UL transmission in any selected subset of duplexing slot/symbol configuration, including FD, XDD, overlapping FD, non-overlapping FD, SBFD, or WTRU-side SBFD

A condition may include a frequency distance between an UL transmission and DL resources. The WTRU may be configured to trigger/to perform the transmission-triggered SRS measurement when the UL transmission is scheduled in resources that are close (in the frequency domain) to DL resources (e.g., DL subband in an SBFD system). For example, the WTRU may receive a configuration indicating a frequency distance threshold between the transmission and the DL resources, and if the frequency distance is smaller than the threshold value, the WTRU may trigger the monitoring.

A condition may include a transmission type. The WTRU may receive the configuration to perform the transmission-triggered SRS measurement for a subset of transmissions, for example., whether the UL transmission was a PUSCH, PUCCH, UL RS, or PRACH. In an example, the WTRU may be configured to only perform the transmission-triggered SRS measurement after transmitting a PUSCH and PRACH transmission, or any other combination.

The WTRU may receive the configuration to perform the transmission-triggered SRS measurement for some UL transmissions, based on the transmission configuration, for example, whether the transmission is periodic, semi-periodic, aperiodic/dynamic, and/or whether the transmission triggered by a configured grant or a dynamic grant. In an example, the WTRU may be configured to trigger the SRS measurement only for periodic/semi-periodic or configured grants (e.g., any transmission that is not dynamically scheduled by the network).

A condition may include WTRU position. The WTRU may receive the configuration to perform the transmission-triggered SRS measurement for transmissions when the WTRU is located in selected positions or geographical areas. For example, the WTRU may be configured to perform the transmission-triggered SRS measurement when operating in or near the cell-edge. For example, the WTRU may be configured to perform the transmission-triggered SRS measurement when close to other WTRUs (e.g., using a threshold in distance between the WTRUs or based on thresholds on signal quality/strength received from another WTRU). For example, the WTRU may be configured to perform the transmission-triggered SRS measurement when the WTRU is located within one or more specific zones that are configured or indicated from the network, where the WTRU may determine a zone the WTRU is currently located in, for example, via a positioning mechanism.

A condition may include measurements. The WTRU may receive the configuration to perform the transmission-triggered SRS measurement based on SSB or CSI-RS measurements, for example, to measure the pathloss to the cell. In an example, the WTRU may be configured to perform the transmission-triggered SRS measurement after an UL transmission if the serving cell measurement is below a given threshold value, for example, indicating that the WTRU is far from the cell center.

In an example, the WTRU may be configured to perform the transmission-triggered SRS measurement after an UL transmission if a neighboring cell measurement is higher than a given threshold value, for example, indicating that the WTRU is far from or next to other cells.

A condition may include transmission power. The WTRU may receive the configuration to perform the transmission-triggered SRS measurement for transmissions using a transmit power beyond (e.g. greater than) a received configuration threshold value. The purpose for this being that a WTRU is more likely to cause CLI when its transmit power is high.

A condition may include a transmit beam. The WTRU may receive the configuration to perform the transmission-triggered SRS measurement for transmissions using a selected set of UL beams, for example, identified via a beam ID, or a RS used for reference for the beams/spatial filters. The purpose for this being that a WTRU may cause CLI when it transmits towards other WTRUs, or depending on the situation, if the beam is towards the cell edges or the cell center.

A condition may include a measured CLI. The WTRU may receive the configuration to perform the transmission-triggered SRS measurement for transmissions when the WTRU measured CLI from another WTRU is beyond (e.g. greater than) a threshold value, for example, based on (L1-)CLI-RSSI or (L1-)CLI-SRS-RSRP measurements, or if the WTRU is aware of CLI or potential CLI from another WTRU (e.g., based on a network indication). The purpose for this being that CLI are likely symmetrical, and if the WTRU receives CLI from another WTRU, it likely may cause CLI to that other WTRU.

Combinations of criterions may also be used as a criterion for transmission-triggered SRS measurement, such as, for example, a combination of the cell measurement, position and transmit power.

To monitor for SBFD CLI, the WTRU may receive a configuration as a combination of resource position (e.g., threshold of frequency distance between UL transmission and the DL subband on the SBFD resources) and transmit power. The rational being that the leakage of interference reduces with frequency distance, so the more frequency distant the transmissions are, the transmission power criterion may be higher, and a combination of both criterions may need to be fulfilled to perform transmission-triggered SRS measurement.

For neighboring cell CLI monitoring, the WTRU may be configured with criterion on both position/pathloss (e.g., being on cell-edge) and the position/pathloss to another neighboring cell and/or transmit power. For example the farther from a neighboring cell the WTRU is, the higher the transmit power criterion may be configured.

Other combinations, other than those discussed above may be used.

After an UL transmissions, the WTRU may verify whether the UL transmission triggers the SRS measurement, based on the received configuration and criterions. If the conditions and criterions are valid (for example, the UL resources are in SBFD resources and the transmit power is greater than a given threshold value), the WTRU may be triggered to measure the SRS.

A WTRU may determine the SRS resources to measure associated with a transmission.

The WTRU may perform a transmission, for example, on UL resources, that is based on a received dynamic or configured grant (e.g., based on a DCI grant, an RRC configuration, and/or a MAC configuration). The transmission may be a data transmission, a control transmission, a reference signal, (e.g., a PUSCH, PUCCH, UL RS) or any other signal. The transmission parameters, for example, received from the network or determined by the WTRU, may include UL transmission resources (e.g., time and/or frequency resources), transmit power, and/or a transmission beam.

In an embodiment, when triggered or configured to perform the transmission-triggered SRS measurement after a transmission, for example, based on determined criterions or indicated by the network, the WTRU may determine the SRS resources associated with the UL transmission resources. The WTRU may determine the SRS resources based on the configuration and/or trigger. In some examples, the WTRU may determine the SRS measurement resources corresponding to a transmission based on one or more of the following.

In an example, when the WTRU triggers the SRS measurement based on (pre)configured resources and criterions, the WTRU may use the received configuration for mapping or associating between the UL transmission resources and the SRS measurement resources and the transmission triggering the SRS measurement.

For example, the WTRU may use a mapping/association or offset between the time of the UL transmission resource and the SRS measurement resource.

In an example, when the WTRU triggers the SRS measurement based on an indication of which SRS measurement resource to use received in the grant/configuration of the transmission, the WTRU may determine the SRS resource using the pre-configured SRS resource and the indicated resource

For example, the indication may indicate an offset, a number of resource to wait, and/or a timing indication to point to one of the (pre)configured SRS resource.

In an example, when the WTRU triggers the SRS measurement based a received SRS measurement resource indicated directly in the grant/configuration of the transmission, the WTRU may use the indicated resource directly.

A WTRU may perform measurements/detections on determined SRS resources.

In an embodiment, the WTRU may determine the reception configuration associated with the SRS measurement resource, for example, based on the SRS measurement resource itself and/or based on the UL transmission that triggered the SRS measurement.

For example, the WTRU may determine a spatial filter or reception beam to perform the SRS measurement based on the transmit parameters of the UL transmission that triggered the monitoring. For example, the WTRU may use the same spatial filter or beam as it used to perform the UL transmission.

In an example, the WTRU may determine, or receive a configuration including a set of spatial filters or reception beams to perform the SRS measurement resources to perform a beam-sweeping on various SRS measurement resources and be able to monitor/receive more accurately the indication. For example, the WTRU may be configured with a set of beams to apply consecutively on the different SRS resources.

In an example, the WTRU may determine to use the same or different reception parameters for the SRS measurement based on whether the SRS measurement resources have the same or different parameters, for example, a same sequence ID. For example, in the case where the WTRU is configured with a repetition of SRS resource for reliability, it may use different reception parameters to increase reception diversity. In the case where the WTRU is configured to receive different SRS resources associated with a given transmission, for example, with different sequences/time/frequency resources, the WTRU may use the same reception parameters, for example, trying to measure/detect SRS from different WTRUs.

In an example, the WTRU may receive a spatial transformation/beam configuration (e.g., as a TCI index, QCL relation, and/or beam index) associated with the different SRS resource(s) or resource set(s). In this case, the WTRU may use the received beam configuration for the SRS measurement.

The WTRU may then perform the SRS measurement associated with the transmission, using determined SRS resources and reception parameters, and using the received measurement configuration. In an example, the WTRU may be configured or may have determined to measure a set of SRS resources, each with a different SRS sequence index and possibly on different time/frequency resources.

A WTRU may determine a subset of the SRS resources to report based on detected SRS.

The WTRU may determine a subset of the measured resources to report, for example, the resources on which the WTRU detected a signal. This may mean that the resources on which other WTRUs sent a SRS as a reaction to the UL transmission.

The WTRU may receive, in the measurement and reporting configuration, the number of measurement resources to report, for example, corresponding to the measurement configuration or to the reporting configuration (e.g. based on the size/format of the report).

The WTRU may be configured to identify/detect which of the configured/determined resource(s) includes a signal, for example., based on a threshold over (L1-)RSRP/RSSI/SINR metrics.

The WTRU may be configured to identify/detect if one or more of the measured resources include a configured set of specific SRS parameters, for example, a subset of the sequence IDs and/or cyclic-shifts. The rational being that the WTRU may monitor shared resources and may only be configured to report/measure SRS resources that corresponds to the received configuration, and if an SRS outside of the configuration is received, the WTRU may not report it.

The WTRU may be configured to detect/measure an SRS on some time/frequency resources and try to detect the presence of SRSs, for example, testing different SRS parameters to detect which parameter is used by other WTRUs (e.g., the sequence ID and/or cyclic-shift).

The WTRU may be configured to select a number of the measured resources, for example, based on sorting the received signal strength (e.g., based on (L1-)RSRP/RSSI/SINR metrics) from strongest to weakest. The WTRU may report both the strongest and weakest measured resources.

The WTRU may identify the resource ID and/or the ID or WTRU associated to the determined subset of resources, based on the received configuration.

The WTRU may report to the network, using the received configuration for reporting, the determined subset of resources/WTRUs that sent an SRS on the measured SRS resources. The WTRU may use the reporting configuration to report, for example, using the indicated reporting resources and format (e.g., UCI or CSI report-based reports). The WTRU may determine the reporting resource based on the SRS measurement timing and its configured associated reports. The report may include one or more of the following.

The report may include (second) WTRU IDs, or IDs associated with the identified received SRS, if available. The report may include an SRS resource (e.g., identified by the resource (set) index). The report may include a signature. For example, if the WTRU is configured to detect and finds a (set of) SRS with their corresponding configured signatures (e.g. based on sequence ID and/or cyclic-shift), it may report which parameters were found.

The report may include measured values. The WTRU may report, for each reported measurement/resource, the measured value (e.g., based on (L1-)SRS-RSRP, RSSI, SINR metrics).

The report may include reception parameter (beams parameter) used for the measurement.

The report may include an associated UL transmission (or transmitted UL channel/signal type), for example, identified using resources of the transmissions or references to the grants

For a CLI-event based SRS transmission, a WTRU (e.g. second side WTRU that may experience CLI) may perform one or more of the following.

A WTRU may receive a (pre)configuration or configuration information (e.g., from the network using, for example RRC signaling). The configuration information may include one or more SRS resource(s) and configurations for transmission, for example, including for each: an index, time and frequency resources, a comb and sequence parameters. The configuration information may include a (L1-)CLI-RSSI measurement configuration, for example, the time, frequency and receiver beam to perform the measurement, and an associated (L1-)CLI-RSSI threshold.

The WTRU may receive an indication to perform the configured CLI-RSSI measurement and an association with one or more of the configured SRS resources, for example, using a DCI, including: the associated SRS resource(s) (e.g., their index); a first time offset indicating the delay between the time resource of the (L1-)CLI-RSSI measurement and the corresponding received DCI; and/or a second time offset indicating the delay between the SRS resource transmission and the time resource of the CLI-RSSI measurement.

The WTRU may perform the configured (L1-)CLI-RSSI measurement on the configured resources, for example, based on the time offset after the DCI indication.

The WTRU may trigger an SRS transmission associated with a CLI event on a condition of detecting a CLI event, for example, if the performed measurement is above or greater than the configured threshold.

The WTRU may determine the time resource of the SRS resources associated with the CLI measurement, based on the received time offset after the CLI measurement resources and the received SRS resource configuration of the indicated associated SRS resource index.

The WTRU may determine the transmission parameters of the associated SRS based on the CLI measurement triggering the SRS transmission. The SRS transmission beam, for example, may be the same as the beam configured for the CLI measurement triggering the SRS transmission. The transmit power, for example, may be based on the CLI-RSSI measurement (e.g., if the CLI-RSSI measurement is above a threshold, use a first transmit power, otherwise use a second transmit power).

The WTRU may transmit the configured SRS resources on the determined time resources, using the determined transmission parameters.

A WTRU may receive the configuration for SRS transmission associated with a CLI event.

Similarly as above, a WTRU (second) may receive the configuration from the network of the resources on which to perform the (SRS) transmissions, associated with a CLI event (i.e., when the WTRU detected a (UL) transmission interfering with a DL transmission).

In an embodiment, the WTRU may receive an indication from the network indicating the configurations for the transmission of signals, for example, a reference signal (e.g. an UL SRS, UL PTRS, UL DMRS, SL CSI-RS, SL SSB, SL DMRS). The (pre)configuration of the resources for transmission is at least the same as the format/resource parameters described above, except that it is configured for transmission instead of reception/measurement. One difference is the usage indication. In an example, the usage may be set to a transmission usage, or may introduce a new usage indicating the CLI management purpose such as ‘CLI management’or ‘event-based’.

In an example, the WTRU may receive the configuration of the SRS resources so that each SRS transmission/reception corresponds to an indication allowing to identify the WTRU. The transmissions are intended to be configured so that another WTRU may be able to measure/detect one or more transmissions from other WTRUs (i.e., the configuration corresponds to configurations sent to other WTRUs (similar mapping and resource configuration)). The SRS configuration/resource may be considered as “signatures” that may uniquely identify the WTRU transmitting it, at least for the network or any entity that knows the signature configuration. The resources may be individually configured as a signature for each (second) WTRUs, and/or for each (first) WTRU. The association between WTRUs and their corresponding resource is typically managed by the network and may use different parameters of the SRS resources (e.g., individual sequence ID, time or frequency resources, and/or patterns).

The (second) WTRU may receive a configuration associating its WTRU ID to a parameter of the SRS resource. For example, the sequence index may be based on its WTRU ID (e.g., using all or part of its ID to set the index value).

The WTRU may receive a configuration associating an SRS transmission configuration (e.g., one or multiple SRS resources) with a CLI event. For example, the WTRU may be configured to perform/trigger an SRS transmission on a configured SRS resource after detecting a CLI event. The configuration of the association may include one or more of the following examples: CLI event/conditions and/or configuration for mapping. The same mapping as previously described may be reused, but where the mapping is between the CLI event (e.g. the time of the resources where CLI happened) and the SRS resources.

A WTRU may determine to transmit an SRS based on one or more CLI events.

In an example, the WTRU may trigger the transmission of an SRS based on a CLI event, and based on the resources/transmissions on which the CLI happened.

The WTRU may detect a CLI based on a (e.g. one or more) measurement.

The measurement may be a CLI measurement. The WTRU may be configured to perform a CLI measurement on some resources (e.g., the WTRU received the measurement configuration from the network). The measurement may be based on RSSI and/or RSRP measurements. In an example, the WTRU may determine that it detected a CLI event when the CLI measurement is beyond or greater than a configured threshold (e.g., based on (L1-)CLI-RSSI measurement).

The measurement may be a network measurement. The WTRU may be configured to perform a (non-CLI) measurement, for example a RS (e.g., CSI-RS, DMRS, SSB). In an example, the WTRU may detect that it received CLI, for example, based on the measurement being lower or less than a threshold (e.g., based on (L1)-RSRP or (L1-)SINR). In an example, the WTRU may determine that it received CLI due to a combination of measurements, metrics and thresholds, for example, the RSSI is beyond or greater than a threshold while the RSRP/SINR is below or less than a threshold. In an example, the WTRU may detect a CLI if the measurement of a network signal (e.g. based on RSRP or SINR) has a change of value over time, for example, based on a threshold on a delta/difference on the metrics. Other combinations of measurements and thresholds may be used.

The WTRU may detect a CLI based on a failed receptions. The WTRU may be configured to trigger a SRS transmission when a scheduled DL reception failed to be received correctly. For example, the WTRU may be configured with a DL grant with some transport format based on its link quality with the network. If the WTRU could not correctly decode the transmission while the link quality was estimated to be good enough (e.g. greater than a threshold), the WTRU may determine that a CLI happened on the DL resources. For example, if the modulation and coding scheme (MCS) is low and the link quality is good, the likelihood of failure is low, so a reception failure may indicate a CLI. The WTRU may consider one or a configured number of failures with a configured window of time to consider the CLI.

In an example, the WTRU may be configured to trigger a SRS transmission when a specific scheduled DL reception failed and the WTRU was configured by the network to trigger SRS transmission for that DL reception. For example, the network may be aware of potential CLI and indicate in the DL assignment (e.g., DCI, MAC or RRC depending on the grant and dynamic/configured scheduling assignment) and add a signaling/parameter that for this transmission, the WTRU may determine a CLI if the reception failed.

The WTRU may detect CLI on SBFD resources. If the WTRU performed strong interference measurements or detected DL failures, the WTRU may determine that these are due to CLI if the measurements or failure happened in SFBD resources. Similarly, the WTRU may determine the CLI event if the resources were in full duplex, overlapping duplex, or XDD types of resources, where same-cell WTRU may cause CLI to the WTRU.

For a transmission type, the WTRU may trigger an SRS transmission depending on the received signal/transmission. For example, the WTRU may trigger an SRS transmission when the CLI happened on a selected (sub)set of receptions (e.g., over a PDCCH, over a DL RS, over a SSB, over a PDSCH, possibly depending on the priority of the reception). For example, the WTRU may trigger an SRS transmission when the CLI happened on receptions that are not dynamically scheduled (e.g. (semi-)periodic receptions). For example, the WTRU may trigger an SRS transmission when the CLI happened on receptions that are dynamically scheduled.

The WTRU may trigger an SRS transmission for transmissions when the WTRU is located in particular or selected positions. For example, the WTRU may trigger an SRS transmission when operating in or near the cell-edge (e.g., using a threshold in distance between the network and the WTRU, or as a threshold in network signal strength/quality). For example, the WTRU may trigger an SRS transmission when close to other WTRUs (e.g., using a threshold in distance between the WTRUs or based on thresholds on signal quality/strength received from another WTRU). For example, the WTRU may trigger an SRS transmission when the WTRU is located within one or more specific zones that are configured or indicated from the network, where the WTRU may determine a zone the WTRU is currently located in (e.g., via a positioning mechanism).

A WTRU may determine the SRS resources to transmit based on a CLI event.

In an embodiment, the WTRU may determine the resources for the SRS transmission based on the received CLI. This aspect has many similarities with the WTRU determining the SRS resources to measure associated with a transmission above, which may be reused here, but where the WTRU may determine the SRS resources based on the received CLI or DL reception instead of the UL transmission.

For example, the WTRU may determine the SRS resources based on pre-configured resources and a mapping/association between the resources that received the CLI and the SRS resources.

In an example, the WTRU may determine the SRS resources based on a network indication (e.g., when indicating that the WTRU may transmit SRS in response to CLI event detection). The resources may be received through the DL reception assignment (e.g., DCI, MAC, RRC).

The WTRU may determine transmission parameters for the SRS, for example, the transmit power and beam, based on the received CLI or on the received transmission/performed measurement.

In an example, the WTRU may use the transmit beam corresponding to the receiving beam of the reception used during the CLI event.

In an example, the WTRU may use a (pre)configured beam for SRSs (e.g., the SRS configuration includes a beam or TCI index associated for the SRS). The WTRU may be configured with different beams for different SRS resources, performing a beam-sweeping transmission to extend the coverage of the SRS transmission.

In an example, the WTRU may use a transmit power based on the received/measured CLI event. For example, if the measured CLI is below or less than a power threshold, the WTRU may use a first transmit power, and if it is higher or greater than the threshold, the WTRU may use a second transmit power. The rational is that if the CLI is strong, it is likely that the source of the CLI is not far and a lower transmit power is sufficient to reach it.

In an example, the WTRU may use a (pre)configured transmit power for SRSs (e.g., the SRS configuration includes an associated transmit power). A fixed transmit power may help the determination of a pathloss between the WTRUs to evaluate their respective impact.

In an embodiment, the WTRU may perform the transmission of the SRS in the determined resources and transmission parameters, and based on the received configuration for SRS transmission (e.g., related to the format and content).

In an embodiment, the WTRU may be configured to first report to the network a detected CLI event, for example, using UCI or a MAC CE indication, and then perform the SRS transmission associated with the CLI event. This allows the network to be aware of the CLI event and of the incoming SRS transmission by the WTRU. The WTRU may then use the configured mapping and association between SRS resources and the CLI event to transmit the SRS.

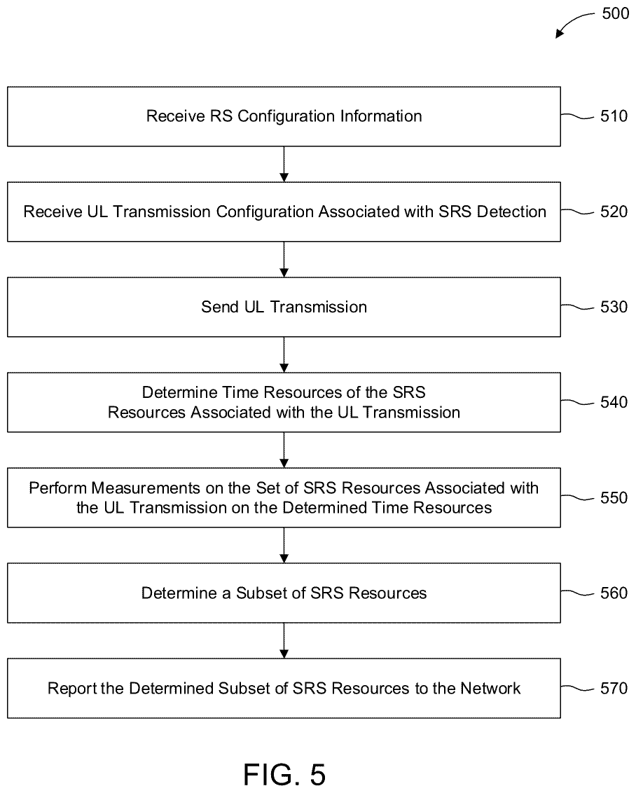

In an embodiment, SRS detection associated with a transmission may be performed, for example as shown in FIG. 5.

A WTRU (e.g., first WTRU, that may cause interference) may be configured with a set of SRS monitoring resources. Each SRS monitoring resource may correspond to a SRS transmission resource of a potential second WTRU, that may be interfered with or may experience interference. Both the first and second WTRUs may be configured with a same association of SRS resource to a transmission or a CLI event. The WTRU may perform a transmission, for example, a scheduled PUSCH transmission, that may cause CLI to some second WTRUs. The second WTRU may determine the CLI event, for example, based on measurements (e.g. CLI-RSSI over the UL sub-band) or based on one or more DL reception failures. If a second WTRU detects a CLI, it may trigger the transmission of the SRS associated with the CLI. The first WTRU may be configured to monitor the set of SRS resources associated with the PUSCH transmission. The first WTRU may detect/identify the SRS resources on which a SRS transmission was performed, if any, and may report the CLI to the network.

A WTRU (first) may receive configuration information 510. The configuration information may be received from a network (e.g., network node). The WTRU may receive the configuration information via, for example, RRC signaling. The configuration information may be reference signal (RS) configuration (e.g., SRS resource configuration) information. The configuration information may comprise information regarding a plurality of SRS resources and configurations, including an index (e.g., index of the SRS resource in the configuration), time resource(s), frequency resource(s), comb, and/or sequence parameters (e.g., sequence identity; used to generate a pseudo-random sequence signal transmitted over the resources). Each SRS resource may correspond to a potential second WTRU. The configuration information may include an associated threshold value (e.g., (L1-)SRS-RSRP).

The WTRU may receive an UL transmission configuration (configuration information) associated with an SRS detection or measurement 520. For example, the UL transmission configuration may include information for a PUSCH transmission. The UL transmission configuration may be received dynamically by, for example, a DCI. The UL transmission configuration may be periodic (e.g., RRC based configuration) or semi-periodic (e.g., RRC +MAC based configuration). The UL transmission configuration may include UL transmission configuration information, for example, a transmission beam, time resources and/or frequency resources. The UL transmission configuration may include an indication to perform an SRS detection or measurement associated with the transmission. The indication may indicate a set of SRS resources from a plurality of configured SRS resources to perform detection on. The UL transmission configuration may include a mapping or association between the UL transmission and the associated set of SRS resources to monitor, for example, based on a time offset starting at the UL transmission. The UL transmission configuration may include a reporting configuration (e.g., UCI format and resources).

The WTRU may perform or send an UL transmission 530. For example, the UL transmission may be a PUSCH transmission based on the received UL transmission configuration. The UL transmission may be performed using the resources and beams indicated by the network.

The WTRU may determine the time resources (e.g. slot/symbol) of the indicated set of SRS resources associated with the UL transmission 540. The determination may be based on the received mapping or association and the UL transmission time resource (e.g. the UL transmission time resource +the received time offset).

The WTRU may perform measurements on the set of SRS resources associated with the performed UL transmission on the determined time resources 550. The WTRU may use as a receiver beam the beam used for the performed UL transmission.

The WTRU may determine a subset of SRS resources 560. The WTRU may determine the subset of SRS resources from among the measured set of SRS resources. The WTRU may determine the subset of SRS resources that are above or greater than a corresponding configured (L1-)SRS-RSRP threshold value.

The WTRU may report the determined subset of SRS resources to the network 570. The WTRU may send the report based on the corresponding received reporting configuration. For example, the report may include the index of the SRS resources from the determined subsets, and/or their measurement value.

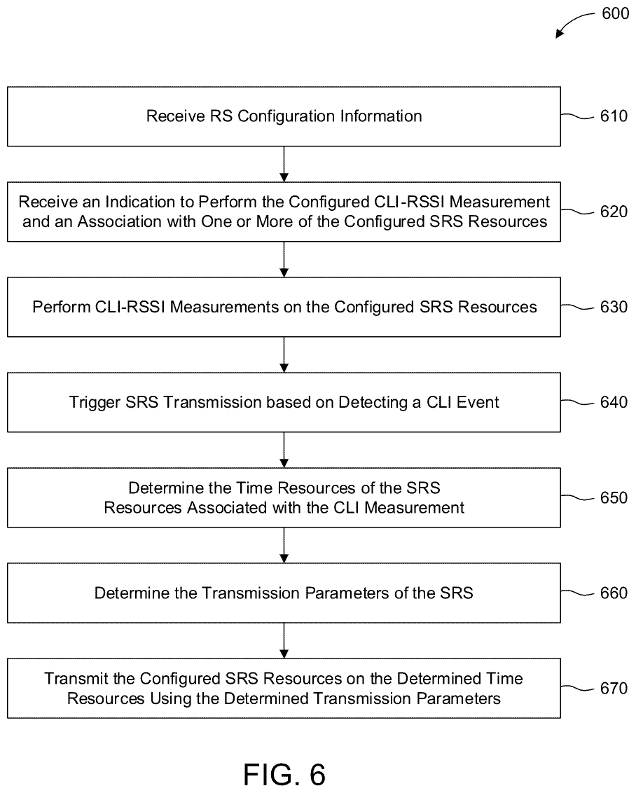

In an embodiment, SRS transmission triggered by a CLI event may be performed, as shown, for example in FIG. 6.

A WTRU (second WTRU that may be interfered with or experience interference) may receive configuration information 610. The configuration information may be received from a network (e.g., network node). The WTRU may receive the configuration information via, for example, RRC signaling. The configuration information may be RS (e.g., SRS) resource configuration information. The configuration information may comprise information regarding one or more SRS resource(s) and configurations for transmission, including for each SRS resource: an index (e.g., index of the SRS resource in the configuration), time resource(s), frequency resource(s), a comb, and sequence parameters (e.g., sequence identity; used to generate a pseudo-random sequence signal transmitted over the resources). The configuration information may comprise a (L1-)CLI-RSSI measurement configuration, for example, the time resource(s), the frequency resource(s), a receiver beam to perform the measurement, and an associated (L1-)CLI-RSSI threshold.

The WTRU may receive an indication to perform the configured CLI-RSSI measurement and an association with one or more of the configured SRS resources 620. The WTRU may receive an indication to perform the configured CLI-RSSI measurement and an association with one or more of the configured SRS resources. The WTRU may receive the indication in, for example a DCI. The DCI may include the associated SRS resource(s) (e.g., their index). The DCI may include a first time offset indicating the delay between the time resource of the (L1-)CLI-RSSI measurement and the corresponding received DCI. The DCI may include a second time offset indicating the delay between the SRS resource transmission and the time resource of the CLI-RSSI measurement.

The WTRU may perform the configured (L1-)CLI-RSSI measurement on the configured resources 630. For example, the WTRU may perform the measurement based on the time offset after the DCI indication.

The WTRU may trigger an SRS transmission associated with a CLI event on a condition of detecting a CLI event 640. For example, the WTRU may detect a CLI event if the performed measurement is above the configured threshold value.

The WTRU may determine the time resources of the SRS resources associated with the CLI measurement 650. The WTRU may determine the time resources of the SRS resources associated with the CLI measurement based on the received time offset after the CLI measurement resources and the received SRS resource configuration of the indicated associated SRS resource index.

The WTRU may determine the transmission parameters of the associated SRS 660. The WTRU may determine the transmission parameters of the associated SRS based on the CLI measurement triggering the SRS transmission. For example, the SRS transmission beam may be the same as the beam configured for the CLI measurement triggering the SRS transmission. For example the transmit power may be based on the CLI-RSSI measurement (e.g., if the CLI-RSSI measurement is above a threshold value, the WTRU may use a first transmit power, otherwise the WTRU may use a second transmit power).

The WTRU may transmit the configured SRS resources on the determined time resources, using the determined transmission parameters 670.

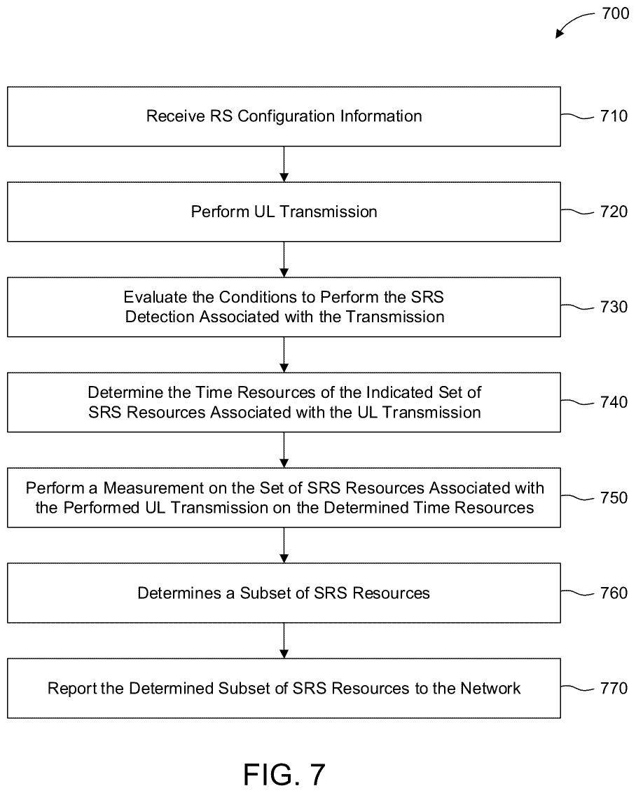

In an embodiment, determination of SRS resources for SRS detection associated with an UL transmission may be performed, for example as shown in FIG. 7. The procedure in FIG. 7 may be used in conjunction with the procedures in FIG. 5 and/or FIG. 6.

In a WTRU-based determination, for example, a first WTRU, that may cause interference, may have a periodic configured grant, and may evaluate whether to monitor for SRS and/or which subset of SRS resources, based on the transmission parameters. The first WTRU may determine the SRS time resources based on a predefined mapping or association. For the WTRU side that experiences interference (e.g., a second WTRU), the second WTRU may perform a DL reception or DL measurement and if a CLI event is detected, the second WTRU may use the preconfigured mapping to determine the time resource on which to transmit the SRS.

A WTRU (first) may receive configuration information 710. The configuration information may be received from a network (e.g., network node). The WTRU may receive the configuration information via, for example, RRC signaling. The configuration information may comprise information regarding a plurality of RS (e.g., SRS) resources and configurations, including an index (e.g., index of the SRS resource in the configuration), time resource(s), frequency resource(s), a comb, and/or sequence parameters (e.g., sequence identity; used to generate a pseudo-random sequence signal transmitted over the resources). Each SRS resource may correspond to a potential second WTRU. The configuration information may comprise an associated threshold value (e.g., (L1-)SRS-RSRP). The configuration information may comprise information regarding a configured grant (e.g., indicating a periodic PUSCH transmission with the corresponding time and frequency resources and transmission beam). The configuration information may comprise an indication to conditionally perform an SRS detection associated with the periodic transmissions. The indication may indicate a mapping or association between the UL transmission resources and their associated SRS resources to monitor, for example, based on a time offset starting at the UL transmissions. The indication may include information regarding reporting configuration (e.g., UCI format and resources), for example, with periodic resources. The indication may indicate a set of SRS resources from the plurality of SRS resources to perform detection on. The indication may include information regarding conditions for which the WTRU may perform the detection, for example, a set of beams, a transmit power threshold value, a resource set, and/or WTRU position.

The WTRU may perform an UL transmission 720, for example, an instance of the periodic PUSCH transmission based on the received transmission configuration, using the resources and beams indicated by the network and transmit power based on a transmit power loop.

The WTRU may evaluate the conditions to perform the SRS detection associated with the transmission 730. The WTRU may evaluate the conditions to perform the SRS detection associated with the transmission based on the received configuration, for example, the WTRU may trigger the SRS detection associated with the transmission if one or more of the following conditions are met: the transmit power is above the configured transmit power threshold value; the beam used for transmission is included in the configured set of beams; the transmission resources are included in the configured set of resources (e.g., transmission in SBFD UL subbands); and/or the WTRU position is at the cell edge (or within a configured value of cell edge).

The WTRU may determine the time resources (e.g. slot/symbol) of the indicated set of SRS resources associated with the UL transmission 740. The WTRU may determine the time resources of the indicated set of SRS resources associated with the UL transmission based on, for example, the received mapping and the UL transmission time resource (e.g., the UL transmission time resource +received time offset).

The WTRU may perform a measurement on the set of SRS resources associated with the performed UL transmission on the determined time resources 750. For example, the WTRU may use as a receiver beam the beam used for the performed UL transmission.

The WTRU may determines a subset of SRS resources 760. The WTRU may determines the subset of SRS resources among the measured set of SRS resources. The WTRU may determines the subset of SRS resources based on the measurement being above the corresponding configured (L1-)SRS-RSRP threshold.

The WTRU may report the determined subset of SRS resources to the network 770. The WTRU may report the determined subset of SRS resources using the corresponding received reporting configuration. For example, the WTRU may use the index of the SRS resources from the determined subsets, and/or their measurement value.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a first wireless transmit/receive unit (WTRU), the method comprising:
receiving reference signal (RS) configuration information, from a network node, wherein the RS configuration information comprises information indicating a plurality of sounding reference signal (SRS) resources;
receiving uplink transmission configuration information, wherein the uplink transmission configuration information comprises information for an uplink transmission, an indication to perform an SRS measurement associated with the uplink transmission, and an association between the uplink transmission and a set of SRS resources to perform the SRS measurements;
transmitting the uplink transmission;
determining time resources of the set of SRS resources associated with the uplink transmission, based on the association between the uplink transmission and a set of SRS resources to perform the SRS measurements;
performing measurements on the set of SRS resources associated with the uplink transmission based on the indication to perform an SRS measurement associated with the uplink transmission and based on the determined time resources;
determining a subset of SRS resources, from the set of SRS resources, to report to the network node, based on the performed measurements; and
sending a report to the network node comprising the determined subset of SRS resources.

2. The method of claim 1, wherein each SRS resource of the plurality of SRS resources corresponds to one or more second WTRUs.

3. The method of claim 1, wherein the RS configuration information comprises SRS resource information including, for each SRS resource, an index, time resources, frequency resources, and a sequence identity, and wherein the RS configuration information comprises a SRS reference signal received power (RSRP) threshold value.

4. The method of claim 3, wherein the determining a subset of SRS resources further comprises:
including an SRS resource in the subset of SRS resources on a condition that the measurement of the SRS resource is greater than the SRS RSRP threshold value.

5. The method of claim 1, wherein the uplink configuration information further comprises: information for a physical downlink shared channel (PUSCH) transmission including a transmission beam, time resources and frequency resources; and reporting configuration information.

6. The method of claim 1, wherein the determining the time resources of the set of SRS resources is determining time resources for each SRS resource of the set of SRS resources.

7. The method of claim 5, wherein the sending the report is based on the reporting configuration information.

8. The method of claim 7, wherein the report includes an index of each SRS resource of the subset of SRS resources and a measurement value of each SRS resource of the subset of SRS resources.

9. The method of claim 1, wherein the uplink transmission is a physical downlink shared channel (PUSCH) transmission and the uplink transmission is transmitted based on the uplink transmission configuration information.

10. The method of claim 1, further comprising:
using a receiver beam for the measurements on the set of SRS resources, wherein the receiver beam is a same beam used for transmitting the uplink transmission.

11. A first wireless transmit/receive unit (WTRU) comprising:
a receiver;
a transmitter; and
a processor, wherein:
the receiver is configured to receive reference signal (RS) configuration information, from a network node, wherein the RS configuration information comprises information indicating a plurality of sounding reference signal (SRS) resources;
the receiver is further configured to receive uplink transmission configuration information, wherein the uplink transmission configuration information comprises information for an uplink transmission, an indication to perform an SRS measurement associated with the uplink transmission, and an association between the uplink transmission and a set of SRS resources to perform the SRS measurements;
the transmitter is configured to transmit the uplink transmission;
the processor is configured to determine time resources of the set of SRS resources associated with the uplink transmission, based on the association between the uplink transmission and a set of SRS resources to perform the SRS measurements;
the processor is further configured to perform measurements on the set of SRS resources associated with the uplink transmission based on the indication to perform an SRS measurement associated with the uplink transmission and based on the determined time resources;
the processor is further configured to determine a subset of SRS resources, from the set of SRS resources, to report to the network node, based on the performed measurements; and
the transmitter is further configured to send a report to the network node comprising the determined subset of SRS resources.

12. The first WTRU of claim 11, wherein each SRS resource of the plurality of SRS resources corresponds to one or more second WTRUs.

13. The first WTRU of claim 11, wherein the RS configuration information comprises SRS resource information including, for each SRS resource, an index, time resources, frequency resources, and a sequence identity, and wherein the RS configuration information comprises a SRS reference signal received power (RSRP) threshold value.

14. The first WTRU of claim 13, wherein the processor is further configured to include an SRS resource in the subset of SRS resources on a condition that the measurement of the SRS resource is greater than the SRS RSRP threshold value.

15. The first WTRU of claim 11, wherein the uplink configuration information further comprises: information for a physical downlink shared channel (PUSCH) transmission including a transmission beam, time resources and frequency resources; and reporting configuration information.

16. The first WTRU of claim 11, wherein the processor is further configured to determine the time resources of the set of SRS resources for each SRS resource of the set of SRS resources.

17. The first WTRU of claim 15, wherein the transmitter is further configured to send the report based on the reporting configuration information.

18. The first WTRU of claim 17, wherein the report includes an index of each SRS resource of the subset of SRS resources and a measurement value of each SRS resource of the subset of SRS resources.

19. The first WTRU of claim 11, wherein the uplink transmission is a physical downlink shared channel (PUSCH) transmission and the uplink transmission is transmitted based on the uplink transmission configuration information.

20. The first WTRU of claim 11, wherein the receiver and the processor are further configured to use a receiver beam for the measurements on the set of SRS resources, wherein the receiver beam is a same beam used for transmitting the uplink transmission.
